SEQUENCE LISTING (5 sequences)

SEQ ID NO: 1 - DNA, 333 bp, Artificial Sequence
  Description of Artificial Sequence Synthetic antibody construct
  CDS (1)..(333)
gacatcgttctcacacagtctcctgctaccttatctgtatctccgggagagagggccaccatctcatgcagggccagccaacgtgtcagttcatctacctatagttatatgcactggtaccaacagaaaccaggacagccacccaaactcctcatcaagtatgcatccaacctagaatctggggtccctgccaggttcagtggcagtgggtctgggactgacttcaccctcaccatctcttctgtggagccggaggattttgcaacatattactgtcagcacagttgggagattcctccgacgttcggtggagggaccaagctcgagattaag

SEQ ID NO: 2 - protein, 111 aa, Artificial Sequence
  Description of Artificial Sequence Synthetic antibody construct
DIVLTQSPATLSVSPGERATISCRASQRVSSSTYSYMHWYQQKPGQPPKLLIKYASNLESGVPARFSGSGSGTDFTLTISSVEPEDFATYYCQHSWEIPPTFGGGTKLEIK

SEQ ID NO: 3 - DNA, 354 bp, Artificial Sequence
  Description of Artificial Sequence Synthetic antibody construct
  CDS (1)..(354)
caggttcagctggtgcagtcaggggctgaagtggtgaagcctggggcttcagtgaagttgtcctgcaaggcttctggctacatcttcaccagttattatatgtactgggtgaagcaggcgcccggacaaggccttgagtggattggagagattaatcctagcaatggtgatactaacttcaatgagaagttcaagagtaaggccacactgactgtagacaaatccgccagcacagcatacatggagctcagcagcctgaggtctgaggacactgcggtctattactgtacaagatcggacggtagaaatgatatggactcctggggccaagggaccctggtcaccgtctcctca

SEQ ID NO: 4 - protein, 118 aa, Artificial Sequence
  Description of Artificial Sequence Synthetic antibody construct
QVQLVQSGAEVVKPGASVKLSCKASGYIFTSYYMYWVKQAPGQGLEWIGEINPSNGDTNFNEKFKSKATLTVDKSASTAYMELSSLRSEDTAVYYCTRSDGRNDMDSWGQGTLVTVSS

SEQ ID NO: 5 - protein, 5 aa, Artificial Sequence
  Description of Artificial Sequence Synthetic linker moiety
GGGGS

(19) United States
(12) Patent Application Publication
(10) Pub. No.: US 2007/0135998 A1
(43) Pub. Date: Jun. 14, 2007

(54) Altered antibodies having improved antigen-binding affinity

(75) Inventors: Herman Van Vlijmen, Mechelen (BE); Brian Woody H. Sherman, Belchertown, MA (US); Alexey Alexandrovich Lugovskoy, Woburn, MA (US)

Correspondence Address: LAHIVE & COCKFIELD, LLP, ONE POST OFFICE SQUARE, BOSTON, MA, 02109-2127, US

(73) Assignees: Biogen Idec MA Inc., Cambridge, MA (US); MASSACHUSETTS INSTITUTE OF TECHNOLOGY, Cambridge, MA (US)

(21) Appl. No.: 11/338,942

(22) Filed: Jan. 24, 2006

Related U.S. Application Data
(63) Continuation of application No. PCT/US04/24200, filed on Jul. 26, 2004.
(60) Provisional application No. 60/490,087, filed on Jul. 26, 2003.

(51) Int. Cl. G06F 19/00

(52) U.S. Cl. 702/19

(57) ABSTRACT

The invention relates to methods of modulating the antigen-binding affinity of an antibody by determining, using data corresponding to the structure of a complex between the antibody and an antigen in a solvent, a representation of a charge distribution of the CDRs of the antibody which minimizes electrostatic contribution to binding free energy between the antibody and the antigen in a solvent. Guided by these determinations, the antibody is accordingly modified (altered) to improve upon, e.g., antibody/antigen binding by modifying at least one amino acid residue to decrease the binding free energy between the antibody and antigen when bound in a solvent.

### RELATED INFORMATION

The application is a continuation of co-pending International Application No. PCT/US2004/024200, filed Jul. 26, 2004, which, in turn, claims priority to U.S. provisional patent application No. 60/490,087, filed on Jul. 26, 2003. The entire contents of the above-identified applications are hereby incorporated by reference in their entirety.

The contents of any patents, patent applications, and references cited throughout this specification are hereby incorporated by reference in their entireties.

### BACKGROUND OF THE INVENTION

Antibodies are exquisite, naturally occurring biological agents that play a critical role in defending the body from pathogens. Antibodies, which are also commonly referred to as immunoglobulins, contain four polypeptides: two longer polypeptides (“heavy chains”) that are identical to one another and two shorter polypeptides (“light chains”) that are identical to one another. The heavy chains are paired with the light chains by disulfide bonds, and the two heavy chains are similarly bound to one another to create a tetrameric structure. Moreover, the heavy and light chains each contain a variable domain and one or more constant regions: the heavy chain includes one variable domain (V_{H}) followed by three constant regions (C₁H, C₂H, and C₃H), and the light chain includes one variable domain (V_{L}) followed by a single constant region (C_{L}).

The variable domains of each pair of light and heavy chains form the site that comes into contact with an antigen. Both V_{H} and V_{L} have the same general structure, with four framework regions (FRs), whose sequences are relatively conserved, connected by three hypervariable or complementarity determining regions (CDRs) (see Kabat et al., In “Sequences of Proteins of Immunological Interest,” U.S. Department of Health and Human Services, 1983; see also Chothia et al., J. Mol. Biol. 196:901-917, 1987). The four framework regions largely adopt a β-sheet conformation and the CDRs form loops connecting, and in some cases forming part of, the β-sheet structure. The CDRs of V_{H} and V_{L} are held in close proximity by the FRs, and amino acid residues within the CDRs bind the antigen. More detailed accounts of the structure of variable domains can be found in Poljak et al. (Proc. Natl. Acad. Sci. USA 70:3305-3310, 1973) Segal et al. (Proc. Natl. Acad. Sci. USA 71:4298-4302, 1974), and Marquart et al. (J. Mol. Biol., 141:369-391, 1980).

Researchers have modified antibodies in various ways in order to study their function or to improve their utility as therapeutic agents. In some of the earliest modifications, researchers used double-stranded DNA sequences to express the V_{H} or V_{L} domains, but none of the sequence of the constant region (see, e.g., EP-A-0 088 994;

Schering Corporation). Other fragments and chimeric antibodies have also been made. One particular type of chimera, commonly referred to as a CDR-grafted antibody, includes sequences from two antibodies that differ in species (e.g., murine CDRs have been used in place of the naturally occurring CDRs in otherwise human antibodies; see, e.g., U.S. Pat. No. 5,225,539). Researchers hoped that such antibodies would be no more foreign to the human body than a genuine human antibody, but the utility of such antibodies has been restricted, at least in some cases, by a reduction in the antibody's affinity for the antigen. In an attempt to improve affinity, some of the amino acids in the FRs of CDR-grafted antibodies have been changed from those of the acceptor molecule (e.g., a human antibody) to those of the antibody that donated the CDRs (e.g., those of a murine antibody; see, e.g., U.S. Pat. No. 5,585,089; U.S. Pat. No. 5,693,761; U.S. Pat. No. 5,693,762; and U.S. Pat. No. 6,180,370).

Accordingly, there remains a need for antibodies that do not provoke a strong immune response but yet bind strongly to their antigens and methods for identifying such antibodies.

### SUMMARY OF THE INVENTION

The present invention is based, in part, on the discovery that the affinity of an antibody (or an antigen-binding fragment thereof) can be improved by modifying amino acid residues within the antibody. The modifications are based, wholly or partially, on a computational analysis of electrostatic forces between the antibody and an antigen to which it binds. The computational analysis, in turn, is based on a prediction of charge distribution within the antibody that generates the electrostatic forces that influence binding between the antibody and its antigen in a solvent (e.g., an aqueous solvent such as water, phosphate-buffered saline (PBS), plasma, or blood). The computational methods define the electrostatic complement (the optimal tradeoff between unfavorable desolvation energy and favorable interactions in an antigen-antibody complex) for a given target site and geometry.

In particular, the invention provides criteria or rules by which one can calculate the optimal charge distribution and associated change in binding free energy between an antibody and an antigen, when bound in a solvent, and then identify discrete residue positions for modification. Moreover, the invention provides rules which guide the selection of an appropriate modification at the identified residue position, e.g., side chain chemistry, by building a subset of modifications in silico followed by recalculating the binding free energy and election of a preferred modification.

Thus, the invention has several advantages in that it, unlike other methods, is not restricted to mere global or pair wise alignment of charges with the presumptive conclusion that only opposite net charges between an antibody and antigen are favorable.

Rather, the invention provides a more sophisticated analysis (as is appropriate given that a typical antibody comprises up to four polypeptide chains with inter and intra chain disulfide linkages and six CDR binding surfaces as well as inter chain interfaces) for revealing the exact residue positions and side chain chemistries to be used to modify the binding-affinity of an antibody/antigen complex.

Moreover, the invention also fully accounts for the binding interactions of a antibody when bound to an antigen within a solvent.

And importantly, the invention provides for antibody modifications that alter antigen-binding which other methods would either fail to identify or dismiss as unsuitable to try.

In one aspect, the invention features a method of modulating the antigen-binding affinity of an antibody that includes the steps of providing data corresponding to the structure (e.g., a three-dimensional structure) of a complex between an antibody and an antigen to which the antibody binds; determining, using the data, a representation of a charge distribution (e.g., a set of multipoles or point charges) within the antibody (e.g., within one or more of the CDRs) that would reduce (i.e., optimize or make more negative) the electrostatic contribution to binding free energy between the antibody and the antigen; and modifying one or more amino acid residues within the antibody (e.g., within one or more of the CDRs) to create a modified antibody corresponding to (or with a better correspondence to) the charge distribution (i.e., the optimal charge distribution determined). The result is a charge distribution that can be used to modulate (e.g., improve, alter, etc.) the interaction between an antibody and its antigen. For example, if the side chain of an amino acid residue in an optimized antibody that has a net total charge of −1, one can replace the corresponding amino acid residue in the original antibody, sometime referred to as the first antibody or parent antibody, with an amino acid residue that has a negatively charged side chain to create a modified antibody which is a variant of the parent antibody and sometimes referred to herein as a second antibody (or even a third or fourth antibody if referring to the modification of a antibody that has been previously modified and is therefore an iterative variation of the preceding antibody).

In a related aspect, the invention provides a method of modulating the antigen-binding affinity of an antibody by determining a spatial representation of an optimal charge distribution of the amino acids of the antibody and associated change in binding free energy of the antibody when bound to an antigen in a solvent; identifying at least one candidate amino acid residue position of the antibody to be modified to alter the binding free energy of the antibody when bound to the antigen; and selecting an elected amino acid residue for substitution for said amino acid position, such that upon substitution, the antigen-binding affinity of the antibody is modulated.

As described further below, once a charge distribution is determined, one or more of the amino acid residues in the antibody (e.g., one or more of the residues in the CDR(s), e.g., 2-10 residues or more, e.g., most if not all of the CDR residues and, optionally, only in the CDR(s)) can be modified to match, or better match, that charge distribution. For example, an amino acid residue can be replaced with another naturally occurring amino acid residue or a non-naturally occurring residue. The substitution may or may not constitute a conservative amino acid substitution. In some instances, it may be desired to alter the charge distribution by deleting or inserting one or more amino acid residues.

In some instances, for example, where the data of the structure of a complex between the antibody and the antigen is available prior to provision of the antibody, one need only know the sequence of the parent antibody (or the sequence of one or more of the CDRs of that antibody). The method can be carried out so long as one has, or can obtain, information regarding the charge distribution within an antibody-antigen complex containing a parent antibody; that information is then used to modify a modified antibody in a way that improves the modified antibody's affinity for its antigen. Alternatively, the methods of the invention can be used to alter (e.g., optimize) the affinity of a fully human antibody or antigen-binding fragments containing human FRs and human CDRs, for example, affinity mature the antibody for improved antigen-binding affinity. A fully human antibody can be one obtained from human plasma (even though this is an uncommon practice) or generated in vivo (e.g., an antibody generated in a transgenic mouse containing human immunoglobulin genes; see U.S. Pat. No. 6,150,584).

In the methods of the invention, the parent and modified antibodies can be of the same or of different species (e.g., the parent antibody can be a non-human antibody (e.g., a murine antibody), and the modified antibody can be a human antibody). The antibodies can also be of the same, or of different, classes or subclasses. Regardless of their origin or class, portions of the sequences of the two antibodies can be identical to one another. For example, the FRs of the parent antibody can be identical to the FRs of the modified antibody. This would occur, for example, where the parent antibody is a human antibody and the modified antibody varies from the parent antibody only in that the modified antibody contains one or more non-human CDRs (i.e., in the modified antibody, one or more of the original, human CDRs have been replaced with a non-human (e.g., murine) CDR).

The methods of the invention can be carried out with antibodies that have the structure of a naturally occurring antibody. For example, the methods of the invention can be carried out with antibodies that have the structure of an IgG molecule (two full-length heavy chains and two full-length light chains). Thus, in some embodiments, the parent and/or modified antibody can include an Fc region of an antibody (e.g., the Fc region of a human antibody). The methods of the invention can be carried out, however, with less than complete antibodies; they can be carried out with any antigen-binding fragment of an antibody including those described further below (Fab fragments, F(ab′)₂ fragments, or single-chain antibodies (scFv)). The “fragments” can constitute minor variations of naturally occurring antibodies. For example, an antibody fragment can include all but a few of the amino acid residues of a “complete” antibody (e.g., the FR of V_{H} or V_{L} can be truncated).

Regardless of whether the method is carried out with a complete antibody or a fragment thereof, where all or part of the FR is present, the sequence of that FR can be that of a wild-type antibody. Alternatively, the FR can contain a mutation. For example, the methods of the invention can be carried out with a parent antibody that includes a framework region (e.g., a human FR) that contains one or more amino acid residues that differ from the corresponding residue(s) in the wild-type FR. The mutation can be one that changes an amino acid residue to the corresponding residue in an antibody of another species. Thus, an otherwise human FR can contain a murine residue (such mutations are referred to in the art as “back mutations”). For example, framework regions of a human antibody can be “back-mutated” to the amino acid residue at the same position in a non-human antibody. Such a back-mutated antibody can be used in the present methods as the “parent” antibody, in which case the “modified” antibody can include completely human FRs. Mutations in the FRs can occur within any of FR1, FR2, FR3, and/or FR4 in either V_{H} or V_{L} (or in V_{H} and V_{L}). Up to about 10 residues or more can be mutated (e.g., 1, 2, 3, 4, 5, 6, 7, 8, 9, or 10 or more residues in FR1, FR2, FR3, and/or FR4 can be changed from the naturally occurring residue (e.g., the human residue) to another residue (e.g., a donor residue, for example, murine residue, at the corresponding position)). The residues that immediately flank the CDRs are among those that can be mutated.

In one embodiment, the methods of the invention are carried out with a parent antibody that is completely non-human (e.g., a murine antibody) and a modified antibody that includes a human Fc region and completely human FRs.

In certain embodiments, the relative affinities of the parent and modified antibodies (e.g., the parent, modified or altered antibody of the present invention) can be such that the affinity of the modified antibody to a given antigen is at least as high as the affinity of the parent antibody to that antigen. For example, the affinity of the modified antibody to the antigen can be at least (or about) 1.1, 1.2, 1.3, 1.4, 1.5, 1.6, 1.7, 1.8, 1.9, 2, 3, 5, 8, 10, 50, 10², 10³, 10⁴, 10⁵, or 10⁶, 10⁷, or 10⁸ times greater than the affinity of the parent antibody to the antigen (or any range or value in between).

The method may also be used lower the affinity of the antibody, for example, where it is desirable to have a lower affinity for better pharmacokinetics, antigen-binding specificity, reduced cross-talk between related antigen epitopes, and the like. For example, the affinity of the modified antibody to the antigen can be at least (or about) 1.1, 1.2, 1.3, 1.4, 1.5, 1.6, 1.7, 1.8, 1.9, 2, 3, 5, 8, 10, 50, 10², 10³, 10⁴, 10⁵, or 10⁶, 10⁷, or 10⁸ times less than the affinity of the parent antibody to the antigen (or any range or value in between).

The methods of the invention can be iterative. An antibody generated, as described above, can be re-modeled (for example, in silico or empirically, e.g., using experimental data) and further altered to further improve antigen binding. Thus, the steps described above can be followed by additional steps, including: obtaining data corresponding to the structure of a complex between the modified antibody and the antigen; determining, using the data (which can be referred to as “additional data” to distinguish it from the data obtained and used in the parent “round”), a representation of an additional charge distribution of the CDRs of the modified antibody which minimizes electrostatic contribution to binding free energy between the modified antibody and the antigen; and expressing a third or further modified antibody that binds to the antigen, the third antibody having a matured CDR differing from a CDR of the modified antibody by at least one amino acid, the matured CDR corresponding to the additional charge distribution. Yet additional rounds of maturation can be carried out. In the method just described, the resulting antibody would be complexed with (i.e. allowed to bind to) antigen and used to obtain a charge distribution that minimizes the electrostatic contribution. A fourth or further modified antibody would then be produced that would contain modifications, dictated by the charge distribution, that improve antigen binding. And so forth.

As noted above, the modified antibody (or subsequent antibodies serving in the place of the modified antibody) can contain a CDR that has been modified so that the electrostatic forces in the antibody-antigen complex are improved (or optimized). Presently, the software used to examine electrostatic forces models an optimal charge distribution and the user then determines what amino acid substitution(s) or alteration(s) would improve that distribution. Accordingly, such steps (e.g., examining the modeled, optimal charge distribution and determining a sequence modification to improve antigen binding) are, or can be, part of the methods now claimed. However, as it would not be difficult to modify the software so that the program includes the selection of amino acid substitutions (or alterations), in the future, one may need only examine that output and execute the suggested change (or some variation of it, if desired).

The methods of the invention may be characterized as those that “produce” an antibody (or a fragment thereof). The term “produce” means to “make,” “generate,” or “design” a non-naturally occurring antibody (or fragment thereof). The antibody produced may be considered more “mature” than either of the antibodies whose sequences (e.g., whose CDR(s) and FRs) were used in its construction. While the antibody produced may have a stronger affinity for an antigen, the methods of the invention are not limited to those that produce antibodies with improved affinity. For example, the methods of the invention can produce an antibody that has about the same affinity for an antigen as it did prior to being modified by the present methods. When a human antibody is modified, as described in the prior art, to contain murine CDRs, the resulting CDR-grafted antibody can lose affinity for its antigen. Thus, for example, where the methods of the invention are applied to CDR-grafted antibodies, they are useful and successful when they prevent the loss of affinity (some or all of the loss) that would otherwise occur with a conventional CDR graft.

In addition to minimizing the electrostatic contribution to the binding free energy, the methods of the invention can further include minimizing the van der Waals or solvent accessible surface area contribution to the binding free energy. In such further computational analysis, additional amino acids in a CDR of the parent antibody may be altered to generate the modified antibody, such that the binding free energy is further reduced beyond what was achieved by solely minimizing the electrostatic contribution. As few as one and as many as 50 CDR residues may be modified in the methods and compositions of the instant invention. Most commonly, between 1 and 10 (e.g., 1, 2, 3, 4, 5, 6, 7, 8, 9, or 10) amino acid residues are altered by the methods and compositions of the instant invention.

Antibodies produced by any of the methods of the invention are also within the scope of the invention, pharmaceutical compositions containing those antibodies, as well as nucleic acids encoding such antibodies. The present invention also includes vectors that express the modified antibodies (or polypeptides or fragments thereof) found by the methods described above. These vectors can be used to transform cell lines, and such transformed (e.g. transfected) cells are within the scope of the invention.

The details of one or more embodiments of the invention are set forth in the description below. Other features, objects, and advantages of the invention will be apparent from the description and the claims.

### BRIEF DESCRIPTION OF THE FIGURES

FIG. 1 illustrates geometries for modeling the binding interactions between an antibody, or antigen-binding fragment thereof, and an antigen, when bound in a solvent (top panel). In particular, the boundary-value problem which comprises a determination of the charge distribution in a spherical region of radius R with a dielectric constant ∈₁, surrounded by solvent with a dielectric constant ∈₂ as well as other geometries of the antibody-antigen interface (bottom panel, see also text, infra).

FIG. 2 depicts nucleotide (SEQ ID NOs: 1, 3) and polypeptide (SEQ ID NOs: 2, 4) sequences for 5c8 heavy variable and light variable chain domains.

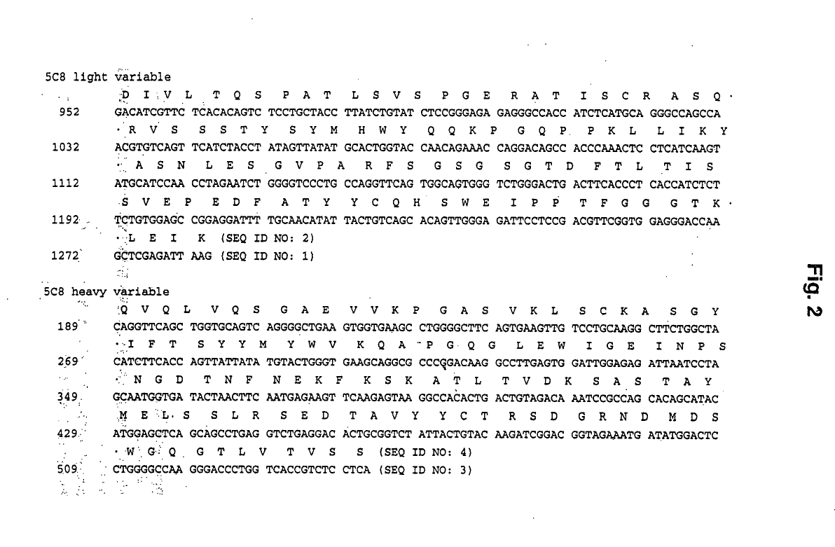

### DETAILED DESCRIPTION OF THE INVENTION

In order to provide a clear understanding of the specification and claims, the following definitions are conveniently provided below.

Definitions

The term “structure”, or “structural data”, as used herein, includes the known, predicted and/or modeled position(s) in three-dimensional space that are occupied by the atoms, molecules, compounds, amino acid residues and portions thereof, and macromolecules and portions thereof, of the invention, and, in particular, an antibody bound to an antigen in a solvent. A number of methods for identifying and/or predicting structure at the molecular/atomic level can be used such as X-ray crystallography, NMR structural modeling, and the like.

The term “binding affinity”, as used herein, includes the strength of a binding interaction and therefore includes both the actual binding affinity as well as the apparent binding affinity. The actual binding affinity is a ratio of the association rate over the disassociation rate. Therefore, conferring or optimizing binding affinity includes altering either or both of these components to achieve the desired level of binding affinity. The apparent affinity can include, for example, the avidity of the interaction. For example, a bivalent altered variable region binding fragment can exhibit altered or optimized binding affinity due to its valency. Binding affinities may also be modeled, with such modeling contributing to selection of residue alterations in the methods of the current invention.

The term “binding free energy” or “free energy of binding”, as used herein, includes its art-recognized meaning, and, in particular, as applied to antibody-antigen interactions in a solvent. Reductions in binding free energy enhance antibody-antigen affinities, whereas increases in binding free energy reduce antibody-antigen affinities.

The phrase “spatial representation of an optimal charge distribution”, as used herein, includes modeling the charge distribution for an antibody or antibody-antigen complex, wherein the electrostatic contribution to free energy of the antibody when bound to antigen is optimized (minimized), as compared to the known and/or modeled representation of charge distribution of the parent antibody and/or parent antibody when bound to antigen. The modeling of optimal charge distribution can be arrived at by an in silico process that incorporates the known and/or modeled structure(s) of an antibody and/or antibody-antigen complex as an input. Response continuum modeling (e.g., the linearized Poisson-Boltzmann equation) can be employed to express the electrostatic binding free energy of the antigen-antibody complex in a solvent as a sum of antibody desolvation, antibody-antigen interaction, and antigen desolvation terms. This in silico process is characterized by the ability to incorporate monopole, dipolar, and quadrupolar terms in representing charge distributions within the modeled charge distributions of the invention, and allows for extensive assessment of solvation/desolvation energies for antibody residues during transition of the antibody between unbound and bound states. The process of modeling the spatial representation of an optimal charge distribution for an antibody-antigen complex may additionally incorporate modeling of van der Waals forces, solvent accessible surface area forces, etc.

The term “solvent”, as used herein, includes its broadest art-recognized meaning, referring to any liquid in which an antibody of the instant invention is dissolved and/or resides.

The term “antibody”, as used herein, includes monoclonal antibodies (including full length monoclonal antibodies), polyclonal antibodies, multispecific antibodies (e.g., bispecific antibodies), chimeric antibodies, CDR-grafted antibodies, humanized antibodies, human antibodies and antigen-binding fragments thereof, for example, an antibody light chain (VL), an antibody heavy chain (VH), a single chain antibody (scFv), a F(ab′)2 fragment, a Fab fragment, an Fd fragment, an Fv fragment, and a single domain antibody fragment (DAb).

The term “antigen”, as used herein, includes an entity (e.g., a proteinaceous entity or peptide) to which an antibody specifically binds, and includes, e.g., a predetermined antigen to which both a parent antibody and modified antibody as herein defined bind. The target antigen may be polypeptide, carbohydrate, nucleic acid, lipid, hapten, or other naturally occurring or synthetic compound. Preferably, the target antigen is a polypeptide.

The term “CDR”, as used herein, includes the complementarity determining regions as described by, for example Kabat, Chothia, or MacCallum et al., (see, e.g., Kabat et al, In “Sequences of Proteins of Immunological Interest,” U.S. Department of Health and Human Services, 1983; Chothia et al., J. Mol. Biol. 196:901-917, 1987; and MacCallum et al., J. Mol. Biol. 262:732-745 (1996); the contents of which are incorporated herein in their entirety).

The amino acid residue positions which typically encompass the CDRs as described by each of the above cited references are set forth below for comparison.

Table of CDR Definitions

| | Kabat | Chothia | MacCallum |
|---|---|---|---|
| V_{H} CDR1 | 31-35 | 26-32 | 30-35 |
| V_{H} CDR2 | 50-65 | 53-55 | 47-58 |
| V_{H} CDR3 | 95-102 | 96-101 | 93-101 |
| V_{L} CDR1 | 24-34 | 26-32 | 30-36 |
| V_{L} CDR2 | 50-56 | 50-52 | 46-55 |
| V_{L} CDR3 | 89-97 | 91-96 | 89-96 |

The term “variable region”, as used herein, includes the amino terminal portion of an antibody which confers antigen binding onto the molecule and which is not the constant region. The term is intended to include functional fragments, for example, antigen-binding fragments, which maintain some or all of the binding function of the whole variable region.

The term “framework region”, as used herein, includes the antibody sequence that is between and separates the CDRs. Therefore, a variable region framework is between about 100-120 amino acids in length but is intended to reference only those amino acids outside of the CDRs. For the specific example of a heavy chain variable region and for the CDRs as defined by Kabat et al., framework region 1 corresponds to the domain of the variable region encompassing amino acids 1-30; region 2 corresponds to the domain of the variable region encompassing amino acids 36-49; region 3 corresponds to the domain of the variable region encompassing amino acids 66-94, and region 4 corresponds to the domain of the variable region from amino acids 103 to the end of the variable region. The framework regions for the light chain are similarly separated by each of the light claim variable region CDRs. Similarly, using the definition of CDRs by Chothia et al. or McCallum et al. the framework region boundaries are separated by the respective CDR termini as described above.

The term terms “modified” or “altered”, as used herein, include antibodies or antigen-binding fragments thereof, that contain one or more amino acid changes in, for example, a CDR(s), a framework region(s), or both as compared to the parent amino acid sequence at the changed position. A modified or altered antibody typically has one or more residues which has been substituted with another amino acid residue, related side chain chemistry thereof, or one or more amino acid residue insertions or deletions.

The term “parent antibody”, “original antibody”, “starting antibody”, “wild-type”, or “first antibody”, as used herein, includes any antibody for which modification of antibody-antigen binding affinity by the methods of the instant invention is desired. Thus, the parent antibody represents the input antibody on which the methods of the instant invention are performed. The parent polypeptide may comprise a native sequence (i.e. a naturally occurring) antibody (including a naturally occurring allelic variant), or an antibody with pre-existing amino acid sequence modifications (such as insertions, deletions and/or other alterations) of a naturally occurring sequence. The parent antibody may be a monoclonal, chimeric, CDR-grafted, humanized, or human antibody.

The terms “antibody variant”, “modified antibody”, “antibody containing a modified amino acid”, “mutant”, or “second antibody”, “third antibody”, etc., as used herein, include an antibody which has an amino acid sequence which differs from the amino acid sequence of a parent antibody. Preferably, the antibody variant comprises a heavy chain variable domain or a light chain variable domain having an amino acid sequence which is not found in nature. Such variants necessarily have less than 100% sequence identity or similarity with the parent antibody. In a preferred embodiment, the antibody variant will have an amino acid sequence from about 75% to less than 100% amino acid sequence identity or similarity with the amino acid sequence of either the heavy or light chain variable domain of the parent antibody, more preferably from about 80% to less than 100%, more preferably from about 85% to less than 100%, more preferably from about 90% to less than 100%, and most preferably from about 95% to less than 100%. Identity or similarity with respect to this sequence is defined herein as the percentage of amino acid residues in the candidate sequence that are identical (i.e. same residue) with the parent antibody residues, after aligning the sequences and introducing gaps, if necessary, to achieve the maximum percent sequence identity. Typically, N-terminal, C-terminal, or internal extensions, deletions, or insertions into the antibody sequence outside of the variable domain are not construed as affecting sequence identity or similarity. The antibody variant is generally one which comprises one or more amino acid alterations in or adjacent to one or more hypervariable regions thereof. The modified antibodies of the present invention may either be expressed, or alternatively, may be modeled in silico.

The phrase “candidate amino acid residue position”, as used herein, includes an amino acid position identified within an antibody of the present invention, wherein the substitution of the candidate amino acid is modeled, predicted, or known to impact charge distribution of the antibody upon alteration, deletion, insertion, or substitution with another amino acid.

The term “elected amino acid”, as used herein, refers to an amino acid residue(s) that has been selected by the methods of the present invention for substitution as a replacement amino acid at the candidate amino acid position within the antibody. Substitution of the candidate amino acid residue position with the elected amino acid residue may either reduce or increase the electrostatic contribution to binding free energy of the antibody-antigen complex.

The terms “amino acid alteration” or “alteration for said amino acid”, as used herein, include refers to a change in the amino acid sequence of a predetermined amino acid sequence. Exemplary alterations include insertions, substitutions, and deletions.

The term “amino acid modification”, as used herein, includes the replacement of an existing amino acid residue side chain chemistry in a predetermined amino acid sequence with another different amino acid residue side chain chemistry, by, for example, amino acid substitution. Individual amino acid modifications of the instant invention are selected from any one of the following: (1) the set of amino acids with nonpolar sidechains, e.g., Ala, Cys, Ile, Leu, Met, Phe, Pro, Val, (2) the set of amino acids with negatively charged side chains, e.g., Asp, Glu, (3) the set of amino acids with positively charged sidechains, e.g., Arg, His, Lys, and (4) the set of amino acids with uncharged polar sidechains, e.g., Asn, Cys, Gln, Gly, His, Met, Phe, Ser, Thr, Trp, Tyr, to which are added Cys, Gly, Met and Phe.

The term “naturally occurring amino acid residue”, as used herein, includes one encoded by the genetic code, generally selected from the group consisting of: alanine (Ala); arginine (Arg); asparagine (Asn); aspartic acid (Asp); cysteine (Cys); glutamine (Gln); glutamic acid (Glu); glycine (Gly); histidine (His); isoleucine (Ile): leucine (Leu); lysine (Lys); methionine (Met); phenylalanine (Phe); proline (Pro); serine (Ser); threonine (Thr); tryptophan (Trp); tyrosine (Tyr); and valine (Val).

The term “non-naturally occurring amino acid residue”. as used herein, includes an amino acid residue other than those naturally occurring amino acid residues listed above, which is able to covalently bind adjacent amino acid residues(s) in a polypeptide chain. Examples of non-naturally occurring amino acid residues include norleucine, ornithine, norvaline, homoserine and other amino acid residue analogues such as those described in Ellman et al. Meth. Enzym. 202:301-336 (1991). To generate such non-naturally occurring amino acid residues, the procedures of Noren et al. Science 244:182 (1989) and Ellman et al., supra, can be used. Briefly, these procedures involve chemically activating a suppressor tRNA with a non-naturally occurring amino acid residue followed by in vitro transcription and translation of the RNA.

The term “exposed” amino acid residue, as used herein, includes one in which at least part of its surface is exposed, to some extent, to solvent when present in a polypeptide (e.g., an antibody or polypeptide antigen) in solution. Preferably, the exposed amino acid residue is one in which at least about one third of its side chain surface area is exposed to solvent. Various methods are available for determining whether a residue is exposed or not, including an analysis of a molecular model or structure of the polypeptide.

The term “treatment” refers to both therapeutic treatment and prophylactic or preventative measures. Those in need of treatment include those already with the disorder as well as those in which the disorder is to be prevented.

The term “disorder or disease” is any condition that would benefit from treatment with the antibody variant. This includes chronic and acute disorders or diseases including those pathological conditions which predispose the mammal to the disorder in question.

The terms “cell”, “cell line”, “cell culture”, or “host cell”, as used herein, includes “transformants”, “transformed cells”, or “transfected cells” and progeny thereof. Host cells within the scope of the invention include prokaryotic cells such as E. coli, lower eukaryotic cells such as yeast cells, insect cells, and higher eukaryotic cells such as vertebrate cells, for example, mammalian cells, e.g., Chinese hamster ovary cells and NS0 myeloma cells.

### DETAILED DESCRIPTION

Overview

The methods described herein can be used to obtain an optimized antibody (or an antigen-binding fragment thereof). Based on a computational analysis, positions are identified within any given antibody where there is a difference (the larger the difference, the more significant it can be) between the charge distribution in an optimized antibody-antigen complex and that in an original antibody-antigen complex. Such differences in charge distribution are also associated with changes in binding free energy of the antibody when bound to the antigen in a solvent. The amino acid residue at such a position can then be changed so that the electrostatic forces in the original antibody more nearly approach (or in alternative embodiments, are more divergent from) those in the optimized antibody, thereby modulating binding free energy of the antibody when bound to an antigen in a solvent. Changes to the antibody are introduced according to a set of discrete criteria or rules as described herein.

Rules for Modifying Antibodies for Improved Function

The rules of the invention can be applied as follows. To modulate the antigen-binding affinity of an antibody, for example, to improve or restore such binding, basic sequence and/or structural data is first acquired. Electrostatic charge optimization techniques are then applied to suggest improved-affinity mutants. Typically, an electrostatic charge optimization is first used to determine the position(s) of the CDR residue(s) that are sub-optimal for binding (Lee and Tidor, J. Chem. Phys. 106:8681-8690, 1997; Kangas and Tidor, J. Chem. Phys. 109:7522-7545, 1998). Then, one or more CDR mutations (i.e., modifications) is subjected to further computational analysis. Based on these calculations, the binding affinity is then determined for a subset of modified antibodies having one or more modifications according to the rules of the invention.

Using a continuum electrostatics model, an electrostatic charge optimization can be performed on each side chain of the amino acids in the CDRs of the antibody. A charge optimization gives charges at atom centers but does not always yield actual mutation(s). Accordingly, a round of charge optimizations can be performed with various constraints imposed to represent natural side chain characteristics at the positions of interest. For example, an optimization can be performed for a net side chain charge of −1, 0, and +1 with the additional constraint that no atom's charge exceeded a particular value, e.g., 0.85 electron charge units. Candidate amino acid side chain positions, and residue modifications at these positions, are then determined based on the potential gain in electrostatic binding free energy observed in the optimizations.

Binding free energy difference (in kcal/mol) in going from the native residue to a completely uncharged sidechain isostere, i.e., a residue with the same shape but no charges or partial charges on the atoms can be calculated. Negative numbers indicate a predicted increase of binding affinity. Optimal charge distribution wherein the net side chain charge is +1, 0, or −1 can be used to calculate the binding free energy difference.

In those instances in which binding free energy difference is favorable (ΔG<−0.25 kcal/mol) and associated with a transition from the native residue to a completely uncharged side chain isostere, i.e., a residue with the same shape but no charges or partial charges on the atoms, modifications from the set of amino acids with nonpolar sidechains, e.g., Ala, Cys, Ile, Leu, Met, Phe, Pro, Val are selected.

Where the binding free energy difference that can be obtained with an optimal charge distribution in the side chain and a net side chain charge of −1 is favorable (ΔG<−0.25 kcal/mol), modifications from the set of amino acids with negatively charged side chains, e.g., Asp, Glu are selected.

Similarly, where the binding free energy difference that can be obtained with an optimal charge distribution in the side chain and a net side chain charge of +1 is favorable (ΔG<−0.25 kcal/mol), modifications from the set of amino acids with positively charged sidechains, e.g., Arg, His, Lys are selected.

Finally, in those cases where the binding free energy difference that can be obtained with an optimal charge distribution in the side chain and a net side chain charge of 0 is favorable (ΔG<−0.25 kcal/mol), modifications from the set of amino acids with uncharged polar sidechains, e.g., Asn, Cys, Gln, Gly, His, Met, Phe, Ser, Thr, Trp, Tyr, to which are added Cys, Gly, Met and Phe are selected.

As described herein, the designed modified antibodies can be built in silico and the binding energy recalculated. Modified side chains can be built by performing a rotamer dihedral scan in CHARMM, using dihedral angle increments of 60 degrees, to determine the most desirable position for each side chain. Binding energies are then calculated for the wild type (parent) and mutant (modified) complexes using the Poisson-Boltzmann electrostatic energy and additional terms for the van der Waals energy and buried surface area.

Results from these computational modification calculations are then reevaluated as needed, for example, after subsequent reiterations of the method either in silico or informed by additional experimental structural/functional data.

The rules allow for several predictions to be made which can be categorized as follows:

1) modifications at the interaction interface involving residues on the antibody that become partially buried upon binding (interactions are improved by making hydrogen bonds with the antigen);

2) modifications of polar residues on the antibody that become buried upon binding and thus pay a desolvation penalty but do not make any direct electrostatic interactions with the antigen (improvements are usually made by modifying to a hydrophobic residue with similar shape to the wild-type residue or by adding a residue that can make favorable electrostatic interactions); and

3) modifications of surface residues on the antibody that are in regions of uncomplementary potentials. These modifications are believed to improve long-range electrostatic interactions between the antibody and antigen without perturbing packing interactions at the binding interface.

Thus practiced, the rules of the invention allow for the successful prediction of affinity altering, e.g., enhancing, side chain modifications. These findings can be classified into three general classes of modifications. The first type of modification involves residues at the interface across from a charged group on the antigen capable of making a hydrogen bond; the second type involves buried polar residues that pay a desolvation penalty upon binding but do not make back electrostatic interactions; and the third type involves long-range electrostatic interactions.

The first type of modification is determined by inspection of basic physical/chemical considerations, as these residues essentially make hydrogen bonds with unsatisfied hydrogen partners of the antigen. Unlike other methods, the rules of the invention allowed for surprising residue modifications in which the cost of desolvation is allowed to outweigh the beneficial interaction energy.

The second type of modification represents still another set of modifications, as the energy gained is primarily a result of eliminating an unfavorable desolvation while maintaining non-polar interactions.

The third type of modification concerns long-range interactions that show potential for significant gain in affinity. These types of modifications are particularly interesting because they do not make direct contacts with the antigen and, therefore, pose less of a perturbation in the delicate interactions at the antibody-antigen interface.

Accordingly, when the desired side chain chemistries are determined for the candidate amino acid position(s) according to the rules, the residue position(s) is then modified or altered, e.g., by substitution, insertion, or deletion, as further described herein.

In addition to the above rules for antibody modification, it is noted that certain determinations, e.g., solvent effects can be factored into initial (and subsequent) calculations of optimal charge distributions.

Obtaining an Antibody or Antigen-Binding Fragment Thereof

The methods of the invention that are aimed at generating a non-naturally occurring antibody (or an antigen-binding fragment thereof) can, but do not necessarily, begin by obtaining an antibody. That antibody may be referred to herein as a “parent” antibody or sometimes as a “first” antibody, and it can be used to obtain information that will allow one to modify or alter one or more amino acid residues either within that antibody (i.e., within the parent antibody) or within a modified or altered antibody having a sequence that is similar to, or that contains portions of, the sequence of the parent antibody. As described herein, for example, one or more of the CDRs (or portions thereof) of a parent antibody, can be replaced with the corresponding CDR(s) of the modified antibody by standard genetic engineering techniques to accomplish the so-called CDR graft or transplant. Accordingly, the method can begin with a mammalian monoclonal or polyclonal antibody (e.g., murine or primate), chimeric, CDR-grafted, humanized, or human antibody.

The parent antibodies can be obtained from art-recognized sources or produced according to art-recognized technologies. For example, the parent antibody can be a CDR-grafted or humanized antibody having CDR regions derived from another source or species, e.g., murine.

The parent antibody or any of the modified antibodies of the invention can be in the format of a monoclonal antibody. Methods for producing monoclonal antibodies are known in the art (see, e.g., Kohler and Milstein, Nature 256:495-497, 1975), as well as techniques for stably introducing immunoglobulin-encoding DNA into myeloma cells (see, e.g., Oi et al., Proc. Natl. Acad. Sci. USA 80:825-829, 1983; Neuberger, EMBO J. 2:1373-1378, 1983; and Ochi et al., Proc. Natl. Acad. Sci. USA 80:6351-6355, 1983). These techniques, which include in vitro mutagenesis and DNA transfection, allow for the construction of recombinant immunoglobulins; these techniques can be used to produce the parent and modified antibodies used in the methods of the invention or to produce the modified antibodies that result from those methods. Alternatively, the parent antibodies can be obtained from a commercial supplier. Antibody fragments (scFvs and Fabs) can also be produced in E. coli (production methods and cellular hosts are described further below).

The parent antibody or any of the modified antibodies of the invention can be an antibody of the IgA, IgD, IgE, IgG, or IgM class.

As noted above, the methods of the invention can be applied to more than just tetrameric antibodies (e.g., antibodies having the structure of an immunoglobulin of the G class (an IgG)). For example, the methods of modifying an antibody can be carried out with antigen-binding fragments of any antibody as well. The fragments can be recombinantly produced and engineered, synthesized, or produced by digesting an antibody with a proteolytic enzyme. For example, the fragment can be an Fab fragment; digestion with papain breaks the antibody at the region, before the inter-chain (i.e., V_{H}-V_{H}) disulphide bond, that joins the two heavy chains. This results in the formation of two identical fragments that contain the light chain and the V_{H} and C_{H}1 domains of the heavy chain. Alternatively, the fragment can be an F(ab′)₂ fragment. These fragments can be created by digesting an antibody with pepsin, which cleaves the heavy chain after the inter-chain disulphide bond, and results in a fragment that contains both antigen-binding sites. Yet another alternative is to use a “single chain” antibody. Single-chain Fv (scFv) fragments can be constructed in a variety of ways. For example, the C-terminus of V_{H} can be linked to the N-terminus of V_{L}. Typically, a linker (e.g., (GGGGS)₄) is placed between V_{H} and V_{L}. However, the order in which the chains can be linked can be reversed, and tags that facilitate detection or purification (e.g., Myc-, His-, or FLAG-tags) can be included (tags such as these can be appended to any antibody or antibody fragment of the invention; their use is not restricted to scFv). Accordingly, and as noted below, tagged antibodies are within the scope of the present invention. In alternative embodiments, the antibodies used in the methods described herein, or generated by those methods, can be heavy chain dimers or light chain dimers. Still further, an antibody light or heavy chain, or portions thereof, for example, a single domain antibody (DAb), can be used.

As the methods of the invention can be iterative, the parent antibody may not be a naturally occurring antibody. As the process of modifying an antibody can be repeated as many times as necessary, the starting antibody (or antigen-binding fragment thereof) can be wholly non-human or an antibody containing human FRs and non-human (e.g., murine) CDRs. That is, the “parent” antibody can be a CDR-grafted antibody that is subjected to the methods of the invention in order to improve the affinity of the antibody, i.e., affinity mature the antibody. As noted above, the affinity may only be improved to the extent that it is about the same as (or not significantly worse than) the affinity of the naturally occurring human antibody (the FR-donor) for its antigen. Thus, the “parent” antibody may, instead, be an antibody created by one or more earlier rounds of modification, including an antibody that contains sequences of more than one species (e.g., human FRs and non-human CDRs). The methods of the invention encompass the use of a “parent” antibody that includes one or more CDRs from a non-human (e.g., murine) antibody and the FRs of a human antibody. Alternatively, the parent antibody can be completely human.

Where the structure is available, of course, one may begin the computational analysis with that structure (rather than creating it again).

The Method of the Invention Informed by Antibody-Antigen Structural Data

Proteins are known to fold into three-dimensional structures that are dictated by the sequences of their amino acids and by the solvent in which a given protein (or protein-containing complex) is provided. The three-dimensional structure of a protein influences its biological activity and stability, and that structure can be determined or predicted in a number of ways. Generally, empirical methods use physical biochemical analysis. Alternatively, tertiary structure can be predicted using model building of three-dimensional structures of one or more homologous proteins (or protein complexes) that have a known three-dimensional structure. X-ray crystallography is perhaps the best-known way of determining protein structure (accordingly, the term “crystal structure” may be used in place of the term “structure”), but estimates can also be made using circular dichroism, light scattering, or by measuring the absorption and emission of radiant energy. Other useful techniques include neutron diffraction and nuclear magnetic resonance (NMR). All of these methods are known to those of ordinary skill in the art, and they have been well described in standard textbooks (see, e.g., Physical Chemistry, 4th Ed., W. J. Moore, Prentiss-Hall, N.J., 1972, or Physical Biochemistry, K. E. Van Holde, Prentiss-Hall, N.J., 1971)) and numerous publications. Any of these techniques can be carried out to determine the structure of an antibody, or antibody-antigen-containing complex, which can then be analyzed according to the methods of the present invention and, e.g., used to inform one or more steps of the method of the invention.

Similarly, these and like methods can be used to obtain the structure of an antigen bound to an antibody fragment, including a fragment consisting of, e.g., a single-chain antibody, Fab fragment, etc. Methods for forming crystals of an antibody, an antibody fragment, or scFv-antigen complex have been reported by, for example, van den Elsen et al. (Proc. Natl. Acad. Sci. USA 96:13679-13684, 1999, which is expressly incorporated by reference herein).

Computational Analysis

The basic computational formulae used in carrying out the methods of the invention are provided in, e.g., U.S. Pat. No. 6,230,102, the contents of which are hereby incorporated by reference in the present application in their entirety.

As noted above, antibodies are altered (or “modified”) according to the results of a computational analysis of electrostatic forces between the antibody and an antigen to which it binds, preferably, in accordance to the discrete criteria or rules of the invention described herein. The computational analysis allows one to predict the optimal charge distribution within the antibody, and one way to represent the charge distribution in a computer system is as a set of multipoles. Alternatively, the charge distribution can be represented by a set of point charges located at the positions of the atoms of the antibody. Once a charge distribution is determined (preferably, an optimal charge distribution), one can modify the antibody to match, or better match, that charge distribution.

The computational analysis can be mediated by a computer-implemented process that carries out the calculations described in U.S. Pat. No. 6,230,102. The computer program is adapted herein to consider the real world context of antigen-antibody binding (and unlike other methods, this methods of the invention take into account, e.g., solvent, long-range electrostatics, and dielectric effects in the binding between an antibody and its antigen in a solvent). The process is used to identify modifications to the antibody structure that will achieve a charge distribution on the “matured” antibody that minimizes the electrostatic contribution to binding free energy between the matured antibody and its antigen (compared to that of the unmodified (“starting” or “parent”) antibody. As is typical, the computer system (or device(s)) that performs the operations described here (and in more detail in U.S. Pat. No. 6,230,102) will include an output device that displays information to a user (e.g., a CRT display, an LCD, a printer, a communication device such as a modem, audio output, and the like). In addition, instructions for carrying out the method, in part or in whole, can be conferred to a medium suitable for use in an electronic device for carrying out the instructions. Thus, the methods of the invention are amendable to a high throughput approach comprising software (e.g., computer-readable instructions) and hardware (e.g., computers, robotics, and chips). The computer-implemented process is not limited to a particular computer platform, particular processor, or particular high-level programming language.

A useful process is set forth in Appendix A (U.S. Pat. No. 6,230,102) and a more detailed exposition is provided in Appendix B (Lee and Tidor (J. Chem. Phys. 106:8681-8690, 1997; each of which is expressly incorporated herein by reference).

Analysis of Affinity

Affinity, avidity, and/or specificity can be measured in a variety of ways. Generally, and regardless of the precise manner in which affinity is defined or measured, the methods of the invention improve antibody affinity when they generate an antibody that is superior in any aspect of its clinical application to the antibody (or antibodies) from which it was made (for example, the methods of the invention are considered effective or successful when a modified antibody can be administered at a lower dose or less frequently or by a more convenient route of administration than an antibody (or antibodies) from which it was made).

More specifically, the affinity between an antibody and an antigen to which it binds can be measured by various assays, including, e.g., a BiaCore assay or the KinExA™ 3000 assay (available from Sapidyne Instruments (Boise, Id.)). The latter assay was used to measure the affinity of AQC2 scFv mutants for the VLA1 I domain (see the Examples below). Briefly, sepharose beads are coated with antigen (in the Examples below, the antigen is a VLA1 I-domain protein, but the antigen used in the methods of the invention can be any antigen of interest (e.g., a cancer antigen; a cell surface protein or secreted protein; an antigen of a pathogen (e.g., a bacterial or viral antigen (e.g., an HIV-antigen, an influenza antigen, or a hepatitis antigen)), or an allergen) by covalent attachment. (It is understood, however, that the methods described here are generally applicable; they are not limited to the production of antibodies that bind any particular antigen or class of antigens.)

Those of ordinary skill in the art will recognize that determining affinity is not always as simple as looking at a single, bottom-line figure. Since antibodies have two arms, their apparent affinity is usually much higher than the intrinsic affinity between the variable region and the antigen (this is believed to be due to avidity). Intrinsic affinity can be measured using scFv or Fab fragments.

Chimeric Antibodies and Antibody Fragments

The term “chimeric antibody” is used to describe a protein comprising at least an antigen-binding portion of an immunoglobulin molecule that is attached by, for example, a peptide bond or peptide linker, to a heterologous protein or a peptide thereof. The “heterologous” protein can be a non-immunoglobulin or a portion of an immunoglobulin of a different species, class or subclass.

There are numerous processes by which such antibodies can be made. For example, one can prepare an expression vector including a promoter that is operably linked to a DNA sequence that encodes at least V_{H} or V_{L} and a sequence that encodes the heterologous protein (or a peptide thereof (the peptide being of a sufficient length that it can be recognized as a non-immunoglobulin molecule (i.e., a peptide having no substantial sequence identity to an immunoglobulin))). If necessary, or desired, one can prepare a second expression vector including a promoter that is operably linked to a DNA sequence that encodes the complementary variable domain (i.e., where the parent expression vector encodes V_{H}, the second expression vector encodes V_{L} and vice versa). A cell line (e.g., an immortalized mammalian cell line) can then be transformed with one or both of the expression vectors and cultured under conditions that permit expression of the chimeric variable domain or chimeric antibody (see, e.g., International Patent Application No. PCT/GB85/00392 to Neuberger et. al.). While Neuberger et al. produced chimeric antibodies in which complete variable domains were encoded by the parent expression vector, this method can be used to express the modified antibodies of the present invention, antibodies containing full-length heavy and light chains, or fragments thereof (e.g., the Fab, F(ab′)₂, or scFv fragments described herein). The methods are not limited to expression of chimeric antibodies.

The antibodies produced by the methods described herein can be labeled just as any other antibody can be labeled. Accordingly, the invention encompasses antibodies produced by the present methods that are labeled with detectable labels such as a radioactive label (e.g., P³² or S³⁵), an enzyme (e.g., horseradish peroxidase, chloramphenicol acetyltransferase (CAT), β-galactosidase (β-gal), or the like), a chromophore or a fluorophore including a quantum dot. The labeled antibodies can be used to carry out diagnostic procedures (many diagnostic assays rely on detection of a protein antigen (such as PSA)) in a variety of cell or tissue types. For imaging procedures, in vitro or in vivo, the altered antibodies produced by the methods described herein can be labeled with additional agents, such as NMR contrasting agents, X-ray contrasting agents, or quantum dots. Methods for attaching a detectable agent to polypeptides, including antibodies or fragments thereof, are known in the art. The antibodies can also be attached to an insoluble support (such as a bead, a glass or plastic slide, or the like).

Construction of Modified Antibodies

Once the sequence of an antibody (e.g., a CDR-grafted or otherwise modified or “humanized” antibody) has been decided upon, that antibody can be made by techniques well known in the art of molecular biology. More specifically, recombinant DNA techniques can be used to produce a wide range of polypeptides by transforming a host cell with a nucleic acid sequence (e.g., a DNA sequence that encodes the desired protein products (e.g., a modified heavy or light chain; the variable domains thereof, or other antigen-binding fragments thereof)).

More specifically, the methods of production can be carried out as described above for chimeric antibodies. The DNA sequence encoding, for example, an altered variable domain can be prepared by oligonucleotide synthesis. The variable domain can be one that includes the FRs of a human acceptor molecule and the CDRs of a donor, e.g., murine, either before or after one or more of the residues (e.g., a residue within a CDR) has been modified to facilitate antigen binding. This is facilitated by determining the framework region sequence of the acceptor antibody and at least the CDR sequences of the donor antibody. Alternatively, the DNA sequence encoding the altered variable domain may be prepared by primer directed oligonucleotide site-directed mutagenesis. This technique involves hybridizing an oligonucleotide coding for a desired mutation with a single strand of DNA containing the mutation point and using the single strand as a template for extension of the oligonucleotide to produce a strand containing the mutation. This technique, in various forms, is described by, e.g., Zoller and Smith (Nuc. Acids Res. 10:6487-6500, 1982), Norris et al. (Nuc. Acids Res. 11:5103-5112, 1983), Zoller and Smith (DNA 3:479-488, 1984), and Kramer et al. (Nuc. Acids Res. 10:6475-6485, 1982).

Other methods of introducing mutations into a sequence are known as well and can be used to generate the altered antibodies described herein (see, e.g., Carter et al., Nuc. Acids Res. 13:4431-4443, 1985). The oligonucleotides used for site-directed mutagenesis can be prepared by oligonucleotide synthesis or isolated from DNA coding for the variable domain of the donor antibody by use of suitable restriction enzymes.

Host Cells and Cell Lines for Expression of the Modified Antibodies

Either the parent antibodies or modified antibodies as described herein (whether in a final form or an intermediate form) can be expressed by host cells or cell lines in culture. They can also be expressed in cells in vivo. The cell line that is transformed (e.g, transfected) to produce the altered antibody can be an immortalised mammalian cell line, such as those of lymphoid origin (e.g., a myeloma, hybridoma, trioma or quadroma cell line). The cell line can also include normal lymphoid cells, such as B-cells, that have been immortalized by transformation with a virus (e.g., the Epstein-Barr virus).

Although typically the cell line used to produce the altered antibody is a mammalian cell line, cell lines from other sources (such as bacteria and yeast) can also be used. In particular, E. coli-derived bacterial strains can be used, especially, e.g., phage display.

Some immortalized lymphoid cell lines, such as myeloma cell lines, in their normal state, secrete isolated Ig light or heavy chains. If such a cell line is transformed with a vector that expresses an altered antibody, prepared during the process of the invention, it will not be necessary to carry out the remaining steps of the process, provided that the normally secreted chain is complementary to the variable domain of the Ig chain encoded by the vector prepared earlier.

If the immortalised cell line does not secrete or does not secrete a complementary chain, it will be necessary to introduce into the cells a vector that encodes the appropriate complementary chain or fragment thereof.

In the case where the immortalised cell line secretes a complementary light or heavy chain, the transformed cell line may be produced for example by transforming a suitable bacterial cell with the vector and then fusing the bacterial cell with the immortalised cell line (e.g., by spheroplast fusion). Alternatively, the DNA may be directly introduced into the immortalised cell line by electroporation.

Pharmaceutical Formulations and Their Uses

In prophylactic applications, pharmaceutical compositions or medicaments are administered to a subject suffering from a disorder in an amount sufficient to eliminate or reduce the risk, lessen the severity, or delay the outset of the disorder, including biochemical, histologic and/or behavioral symptoms of the disorder, its complications and intermediate pathological phenotypes presenting during development of the disorder. In therapeutic applications, compositions or medicaments are administered to a subject suspected of, or already suffering from such a disorder in an amount sufficient to cure, or at least partially arrest, the symptoms of the disorder (biochemical, histologic and/or behavioral), including its complications and intermediate pathological phenotypes in development of the disorder.

Effective doses of the compositions of the present invention, for the treatment of a condition vary depending upon many different factors, including means of administration, target site, physiological state of the subject, whether the subject is human or an animal, other medications administered, and whether treatment is prophylactic or therapeutic. Usually, the subject is a human but non-human mammals including transgenic mammals can also be treated.

For passive immunization with an antibody, the dosage ranges from about 0.0001 to 100 mg/kg, and more usually 0.01 to 20 mg/kg, of the host body weight. For example dosages can be 1 mg/kg body weight or 10 mg/kg body weight or within the range of 1-10 mg/kg, e.g., at least 1 mg/kg. Subjects can be administered such doses daily, on alternative days, weekly or according to any other schedule determined by empirical analysis. An exemplary treatment entails administration in multiple dosages over a prolonged period, for example, of at least six months. Additional exemplary treatment regimes entail administration once per every two weeks or once a month or once every 3 to 6 months. Exemplary dosage schedules include 1-10 mg/kg or 15 mg/kg on consecutive days, 30 mg/kg on alternate days or 60 mg/kg weekly. In some methods, two or more monoclonal antibodies with different binding specificities are administered simultaneously, in which case the dosage of each antibody administered falls within the ranges indicated.

Antibody is usually administered on multiple occasions. Intervals between single dosages can be weekly, monthly or yearly. In some methods, dosage is adjusted to achieve a plasma antibody concentration of 1-1000 mg/ml and in some methods 25-300 μg/ml. Alternatively, antibody can be administered as a sustained release formulation, in which case less frequent administration is required. Dosage and frequency vary depending on the half-life of the antibody in the subject. In general, human antibodies show the longest half-life, followed by humanized antibodies, chimeric antibodies, and nonhuman antibodies, in descending order.

The dosage and frequency of administration can vary depending on whether the treatment is prophylactic or therapeutic. In prophylactic applications, compositions containing the present antibodies or a cocktail thereof are administered to a subject not already in the disease state to enhance the subject's resistance. Such an amount is defined to be a “prophylactic effective dose.” In this use, the precise amounts again depend upon the subject's state of health and general immunity, but generally range from 0.1 to 25 mg per dose, especially 0.5 to 2.5 mg per dose. A relatively low dosage is administered at relatively infrequent intervals over a long period of time. Some subjects continue to receive treatment for the rest of their lives.

In therapeutic applications, a relatively high dosage (e.g., from about 1 to 200 mg of antibody per dose, with dosages of from 5 to 25 mg being more commonly used) at relatively short intervals is sometimes required until progression of the disease is reduced or terminated, and preferably until the subject shows partial or complete amelioration of symptoms of disease. Thereafter, the patent can be administered a prophylactic regime.

Therapeutic agents can be administered by parenteral, topical, intravenous, oral, subcutaneous, intraarterial, intracranial, intraperitoneal, intranasal or intramuscular means for prophylactic and/or therapeutic treatment. The most typical route of administration of a protein drug is intravascular, subcutaneous, or intramuscular, although other routes can be effective. In some methods, agents are injected directly into a particular tissue where deposits have accumulated, for example intracranial injection. In some methods, antibodies are administered as a sustained release composition or device, such as a Medipad™ device. The protein drug can also be administered via the respiratory tract, e.g., using a dry powder inhalation device.

Agents of the invention can optionally be administered in combination with other agents that are at least partly effective in treatment of immune disorders.

The pharmaceutical compositions of the invention include at least one antibody of the invention in a pharmaceutically acceptable carrier. A “pharmaceutically acceptable carrier” refers to at least one component of a pharmaceutical preparation that is normally used for administration of active ingredients. As such, a carrier may contain any pharmaceutical excipient used in the art and any form of vehicle for administration. The compositions may be, for example, injectable solutions, aqueous suspensions or solutions, non-aqueous suspensions or solutions, solid and liquid oral formulations, salves, gels, ointments, intradermal patches, creams, lotions, tablets, capsules, sustained release formulations, and the like. Additional excipients may include, for example, colorants, taste-masking agents, solubility aids, suspension agents, compressing agents, enteric coatings, sustained release aids, and the like.

Agents of the invention are often administered as pharmaceutical compositions including an active therapeutic agent and a variety of other pharmaceutically acceptable components. See Remington's Pharmaceutical Science (15th ed., Mack Publishing Company, Easton, Pa. (1980)). The preferred form depends on the intended mode of administration and therapeutic application. The compositions can also include, depending on the formulation desired, pharmaceutically acceptable, non-toxic carriers or diluents, which are defined as vehicles commonly used to formulate pharmaceutical compositions for animal or human administration. The diluent is selected so as not to affect the biological activity of the combination. Examples of such diluents are distilled water, physiological phosphate-buffered saline, Ringer's solutions, dextrose solution, and Hank's solution. In addition, the pharmaceutical composition or formulation may also include other carriers, adjuvants, or nontoxic, nontherapeutic, nonimmunogenic stabilizers and the like.

Antibodies can be administered in the form of a depot injection or implant preparation, which can be formulated in such a manner as to permit a sustained release of the active ingredient. An exemplary composition comprises monoclonal antibody at 5 mg/ml, formulated in aqueous buffer consisting of 50 mM L-histidine, 150 mM NaCl, adjusted to pH 6.0 with HCl. Another example of a suitable formulation buffer for monoclonal antibodies contains 20 mM sodium citrate, pH 6.0, 10% sucrose, 0.1% Tween 80.

Typically, compositions are prepared as injectables, either as liquid solutions or suspensions; solid forms suitable for solution in, or suspension in, liquid vehicles prior to injection can also be prepared. The preparation also can be emulsified or encapsulated in liposomes or microparticles such as polylactide, polyglycolide, or copolymer for enhanced adjuvant effect, as discussed above (see Langer, Science 249: 1527 (1990) and Hanes, Advanced Drug Delivery Reviews 28:97 (1997)).

Therapies

Treatment of a subject suffering from a disease or disorder can be monitored using standard methods. Some methods entail determining a baseline value, for example, of an antibody level or profile in a subject, before administering a dosage of agent, and comparing this with a value for the profile or level after treatment. A significant increase (i.e., greater than the typical margin of experimental error in repeat measurements of the same sample, expressed as one standard deviation from the mean of such measurements) in value of the level or profile signals a positive treatment outcome (i.e., that administration of the agent has achieved a desired response). If the value for immune response does not change significantly, or decreases, a negative treatment outcome is indicated.

In other methods, a control value (i.e., a mean and standard deviation) of level or profile is determined for a control population. Typically the individuals in the control population have not received prior treatment. Measured values of the level or profile in a subject after administering a therapeutic agent are then compared with the control value. A significant increase relative to the control value (e.g., greater than one standard deviation from the mean) signals a positive or sufficient treatment outcome. A lack of significant increase or a decrease signals a negative or insufficient treatment outcome. Administration of agent is generally continued while the level is increasing relative to the control value. As before, attainment of a plateau relative to control values is an indicator that the administration of treatment can be discontinued or reduced in dosage and/or frequency.

In other methods, a control value of the level or profile (e.g., a mean and standard deviation) is determined from a control population of individuals who have undergone treatment with a therapeutic agent and whose levels or profiles have plateaued in response to treatment. Measured values of levels or profiles in a subject are compared with the control value. If the measured level in a subject is not significantly different (e.g., more than one standard deviation) from the control value, treatment can be discontinued. If the level in a subject is significantly below the control value, continued administration of agent is warranted. If the level in the subject persists below the control value, then a change in treatment may be indicated.

In other methods, a subject who is not presently receiving treatment but has undergone a previous course of treatment is monitored for antibody levels or profiles to determine whether a resumption of treatment is required. The measured level or profile in the subject can be compared with a value previously achieved in the subject after a previous course of treatment. A significant decrease relative to the previous measurement (i.e., greater than a typical margin of error in repeat measurements of the same sample) is an indication that treatment can be resumed. Alternatively, the value measured in a subject can be compared with a control value (mean plus standard deviation) determined in a population of subjects after undergoing a course of treatment. Alternatively, the measured value in a subject can be compared with a control value in populations of prophylactically treated subjects who remain free of symptoms of disease, or populations of therapeutically treated subjects who show amelioration of disease characteristics. In all of these cases, a significant decrease relative to the control level (i.e., more than a standard deviation) is an indicator that treatment should be resumed in a subject.

The antibody profile following administration typically shows an immediate peak in antibody concentration followed by an exponential decay. Without a further dosage, the decay approaches pretreatment levels within a period of days to months depending on the half-life of the antibody administered. For example the half-life of some human antibodies is of the order of 20 days.

In some methods, a baseline measurement of antibody to a given antigen in the subject is made before administration, a second measurement is made soon thereafter to determine the peak antibody level, and one or more further measurements are made at intervals to monitor decay of antibody levels. When the level of antibody has declined to baseline or a predetermined percentage of the peak less baseline (e.g., 50%, 25% or 10%), administration of a further dosage of antibody is administered. In some methods, peak or subsequent measured levels less background are compared with reference levels previously determined to constitute a beneficial prophylactic or therapeutic treatment regime in other subjects. If the measured antibody level is significantly less than a reference level (e.g., less than the mean minus one standard deviation of the reference value in population of subjects benefiting from treatment) administration of an additional dosage of antibody is indicated.

Additional methods include monitoring, over the course of treatment, any art-recognized physiologic symptom (e.g., physical or mental symptom) routinely relied on by researchers or physicians to diagnose or monitor disorders.

The following examples are included for purposes of illustration and should not be construed as limiting the invention.

### Exemplification

Throughout the examples, the following materials and methods were used unless otherwise stated.

Materials and Methods

In general, the practice of the present invention employs, unless otherwise indicated, conventional techniques of chemistry, molecular biology, recombinant DNA technology, immunology (especially, e.g., antibody technology), and standard techniques in electrophoresis. See, e.g., Sambrook, Fritsch and Maniatis, Molecular Cloning: Cold Spring Harbor Laboratory Press (1989); Antibody Engineering Protocols (Methods in Molecular Biology), 510, Paul, S., Humana Pr (1996); Antibody Engineering: A Practical Approach (Practical Approach Series, 169), McCafferty, Ed., Irl Pr (1996); Antibodies: A Laboratory Manual, Harlow et al., C.S.H.L. Press, Pub. (1999); and Current Protocols in Molecular Biology, eds. Ausubel et al., John Wiley & Sons (1992).

Generation of Antibodies and Antigen-Binding Fragments Thereof

The selection, cloning, and manufacture of antibodies, for example, chimeric, humanized, monoclonal, and single-chain antibodies is well described in the art. In addition, the humanization of hu5c8 mAb has been described previously. See Lederman, 1992 and Karpusas, 2001, respectively. This antibody is available from the ATCC (PTA-4931). The 5c8 antibody was stably expressed in NS0 myeloma cells and purified by Protein A and gel filtration chromatography. SDS-PAGE and analytical gel filtration chromatography demonstrated that the protein formed the expected disulfide linked tetramer. The single-chain antibodies of the invention were typically expressed in E. coli and immunopurified using standard techniques.

AQC2 scFv Production

AQC2 scFv is expressed by plasmid pKJS217. This plasmid contains 318 nucleotides of the AQC2 light chain encoding the 106 amino acid light chain variable region followed in frame by 45 nucleotides encoding 3 copies of a GGGGS linker moiety. The linker is followed in frame by 360 nucleotides encoding the 120 amino acid AQC2 heavy chain variable region. Immediately following the heavy chain variable region is an enterokinase cleavage site and myc and HIS tags. Expression was done in E. coli and is driven by the ara-BAD promoter and the protein is directed to the periplasmic space by an 80 nucleotide fragment encoding the g111 peptide from the bacteriophage fd. This peptide was cleaved from the protein during periplasmic export.

5C8 Fab Production

The 5C8 Fab fragment was expressed by the bicistronic plasmid pBEF064. The first cistron contains 354 nucleotides of the 5C8 heavy chain encoding the 118 amino acid heavy chain variable region followed in frame by 306 nucleotides encoding the first 102 amino acids of the human IgG1 constant domain and 18 nucleotides encoding a 6 histidine tag. A second ribosome entry site is located 7 nucleotides after the end of the heavy chain cistron. The second cistron contains 333 nucleotides encoding the 111 amino acid 5C8 light chain variable region followed in frame by 321 nucleotides encoding the 107 amino acid light chain constant domain. Expression was done in E. coli and is driven by the ara-BAD promoter and the heavy and light chains are directed to the periplasmic space by the OmpA (heavy chain) and PhoA (light chain) periplasmic localization signals. The periplasmic localization signals are cleaved from the protein during periplasmic export.

Binding Assays

Binding assays were typically performed using the KinExA™ kit. The assay is carried out by passing a dilute solution of the antibody (or antigen-binding fragment) through the column provided in the kit, and some of the antibody (or the antigen-binding fragment thereof) interacts with the antigen on the bead. The antibody (or the fragment) is then detected with a secondary anti-human IgG heavy and light chain antibody conjugated with the fluorescent dye Cy5 (Jackson ImmunoResearch Laboratories, Inc., West Grove, Pa.). The concentration of the antibody (or the fragment) is set so that the signal from the fluorescent dye is proportional to the concentration of protein. To obtain the solution phase affinity of the interaction, the antibody (or the fragment) is mixed with a dilution series of soluble antigen. These proteins (antibody and antigen) are allowed to reach equilibrium during a three-hour incubation at room temperature or an overnight incubation at 4° C. The mixture is flowed over the antigen-containing column, and the signal is proportional to the amount of unbound antibody (or antibody fragment) that remains in solution. The resulting data can be plotted on a linear-log scale graph and fit to a quadratic curve by non-linear regression, which gives a value for the K_{D}.

Binding assay 5C8-CD40L

An ELISA-based competitive binding assay was done. Anti c-myc mAb was coated onto NUNC Maxisorb plates at 10 ug/mL in PBS for 2 hrs at room temperature. Serial dilutions of unlabeled 5C8 Fab (mutants or wildtype) were made and mixed with equal volumes of fixed concentration (30 ng/ml) of biotin-labeled 5C8 Fab competitor, and added to the plate. After 2 hours incubation at room temperature, the plate was washed and bound biotin-labeled 5C8 Fab competitor was detected with streptavidin-HRP. Binding affinities were obtained from four parameter curve fits.

Computer Modeling Metrics and Formulae

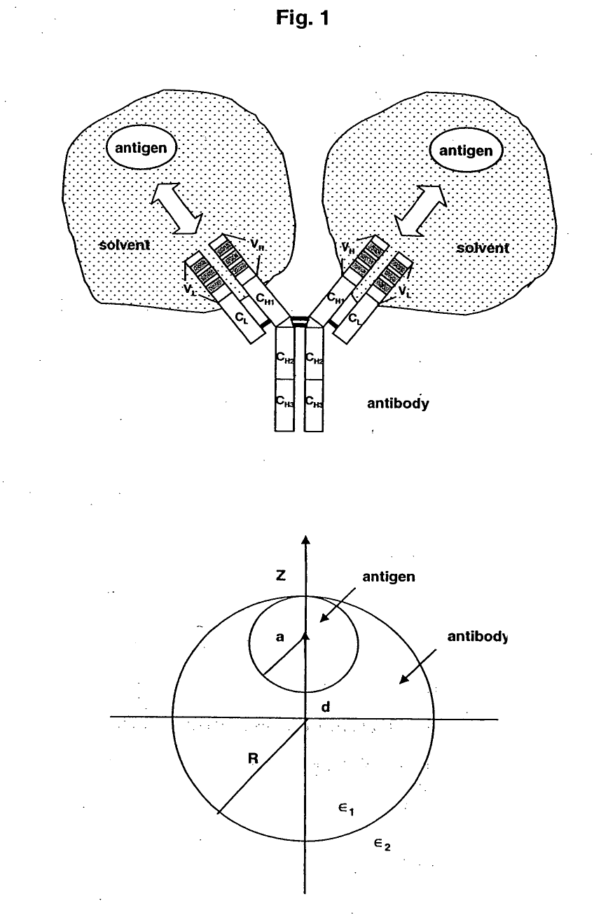

For carrying out the optimization of an antibody according to the invention, the following metrics and formulae can be used. For example, the free energy of binding difference between the electrostatic free energy in the bound and the unbound state of antibody can be represented as such, ΔG_{binding}=G^{bound}−G^{unbound} (see FIG. 1a). Because the dielectric model includes responses that affect the entropy as well as the enthalpy, the electrostatic energy is considered to be a free energy. The free energy of each state is expressed as a sum of coulombic and reaction-field (hydration) terms involving the antigen (L), the antibody (or antigen-binding fragment thereof) (R), and their interaction (L-R):

$${G}^{state} = {G}_{coul , L}^{state} + {G}_{coul , R}^{state} + {G}_{coul , L - R}^{state} + {G}_{hyd , L}^{state} + {G}_{hyd , R}^{state} + {G}_{hyd , L - R}^{state} . \qquad ( 1 )$$

This results in the following expression for the binding free energy,
ΔG_{binding}=ΔG_{coul,L-R}+ΔG_{hyd,L-R}+ΔG_{hyd,L}+ΔG_{hyd,R} (2)
where the fact that the geometry of point charges in the antigen and antibody remain fixed is used in the model to cancel the coulombic self contribution of antibody and antigen and where the two L-R terms are due only to the bound state because the antibody and antigen are assumed not to interact in the unbound state. (Note, however, that the charge distribution for the antigen need not be the same in the bound and unbound states. If they are different, this adds a constant to ΔG_{binding} that can be dropped in defining ΔGᵥₐᵣ in Eq. (3)). Thus, Eq. (2) describes the electrostatic binding free energy as a sum of desolvation contributions of the antibody and the antigen (which are unfavorable) and solvent screened electrostatic interaction in the bound state (which is usually favorable). Since the goal is to vary the antibody charge distribution to optimize the electrostatic binding free energy and the last term simply adds a constant, a relevant variational binding energy is defined,
ΔGᵥₐᵣ=ΔG_{irs,L-R}+ΔG_{hyd,L,} (3)
in which the first two terms on the right hand side (RHS) of Eq. (2) have been combined into a screened interaction term and the constant term has been dropped. Note that

$$\begin{matrix}Δ G \text{?} = {\sum }_{j ∈ R} {q}_{j} {V}_{L}^{bound} ( \vec{{r}_{j}} ) = {\sum }_{j ∈ R} {q}_{j} [ {V}_{coul , L}^{bound} ( \vec{{r}_{j}} ) + {V}_{hyd , L}^{bound} ( \vec{{r}_{j}} ) ] \\ and & ( 4 ) \\ Δ {G}_{hyd , L} = \frac{1}{2} {\sum }_{i ∈ L} {q}_{i} {V}_{hyd , L}^{bound} ( \vec{{r}_{i}} ) - \frac{1}{2} {\sum }_{i ∈ L} {q}_{i} {V}_{hyd , L}^{unbound} ( \vec{{r}_{i}} ) \\ \text{?} \text{indicates text missing or illegible when filed} & ( 5 )\end{matrix}$$

where V_{L}^{state} is the total electrostatic potential in the indicated state due to the antibody charge distribution only and V_{term,L}^{state} is the coulombic or reaction-field (hydration) term, as indicated. The summations are over atomic point charges in the antibody (i∈L) or antigen j∈R). The factor of ½ in Eq. (5) is due to the fact that the antibody charge distribution interacts with the self-induced reaction field. V_{coul,L}^{bound}, V_{hyd,L}^{bound}, and V_{hyd,L}^{unbound}, the three electrostatic potentials in Eqs. (4) and (5), are expressed in terms of the given geometry and charge distribution by solving the boundary-value problem shown in FIG. 1b. A charge distribution (corresponding to the antibody) is embedded in a sphere of radius R. The center of the sphere is taken as the origin of coordinates (unprimed) but the charge distribution in multipoles is expanded about a second origin (primed) translated a distance d along the z-axis, so that
\vec{r}(r_{z}θ_{z}φ)=\vec{d}(d_{z}θᵤ=1)_{z}φᵤ=0)+\vec{r}ⁱ(rⁱ_{z}θⁱ_{z}φⁱ). (6)

The potential everywhere satisfies the Poisson equation. Inside the sphere, it may be written as,

$${V}_{in} ( \vec{r} ) = {\sum }_{i} \frac{{q}_{i}}{{ε}_{1} \vert \vec{r} - \vec{{r}_{i}} \vert} + {\sum }_{l = 0}^{∞} {\sum }_{m = - 1}^{ l} {A}_{l , m} \text{?} {Y}_{l , m} ( θ , ϕ ) \\ \text{?} \text{indicates text missing or illegible when filed} \qquad ( 7 )$$

where the first term on the RHS is the coulombic and the second is the reaction-field (hydration) potential, and the summation over i corresponds to the antibody point charges. Outside the sphere, the coulombic and reaction-field potential can be combined and written as,

$${V}_{out} ( \vec{r} ) = {\sum }_{l = 0}^{∞} {\sum }_{m = - 1}^{l } \frac{{B}_{l , m}}{{y}^{l - 1}} {Y}_{l , m} ( θ , ϕ ) \qquad ( 8 )$$

where A_{l,m} and B_{l,m} are to be determined by the proper boundary conditions and Y_{l,m}(θ, φ) are the spherical harmonics. The coulombic term in Eq. (7) is expanded in spherical harmonics and multipoles of the charge distribution about the center of the sphere. Here the origin of the multipole expansion is shifted to \vec{d},

$$\begin{matrix}{\sum }_{i} \frac{{q}_{i}}{{ε}_{1} \vert \vec{r} - \vec{{r}_{i}} \vert} = {\sum }_{i} \frac{{q}_{i}}{{ε}_{1} \vert ( \vec{r} - \vec{d} ) - \vec{{r}_{i}^{′}} \vert} \\ = {\sum }_{i} \frac{{q}_{i}}{{ε}_{1} \vert \vec{r} - \vec{{r}_{i}^{′}} \vert} \\ = {\sum }_{l = 0}^{∞} {\sum }_{m = - 1}^{l } \frac{4 π}{2 l + 1} {Q}_{l , m}^{′ *} \frac{{Y}_{l , m} ( {θ}^{′} , {ϕ}^{′} )}{{ε}_{1} {r}^{′ l + 1}}\end{matrix} \qquad \begin{matrix}( 9 ) \\ \\ \\ \\ \\ ( 10 )\end{matrix}$$

where Q′_{l,m} is a spherical multipole expanded about the primed origin, \vec{d},

$${Q}_{l , m}^{′ *} ≡ {\sum }_{i} {q}_{i} {r}_{i}^{′ l} {Y}_{l , m}^{*} ( {θ}_{i}^{′} , {ϕ}_{i}^{′} ) . \qquad ( 11 )$$

The definition of the Y_{l,m}(θ, φ) used by Jackson is adopted (J, D. Jackson, Electrodynamics, 2nd ed, (John Wiley and Sons. New York. 1975).

The expression in Eq. (10) is valid for r′>r′i (i.e., outside the antibody or, more precisely, outside the sphere whose
center is at \vec{d} and whose radius is the longest distance between \vec{d} and a point charge). To substitute into Eq. (7) and combine terms involving spherical harmonics, first Y_{l,m}(θ′, φ′)/r′^{l+1} of Eq. (10) was expanded in terms of Y_{l,m}(θ, φ)/r^{l+1}. This was done using the results of Greengard (The Rapid Evaluation of Potential Fields in Particle Systems MIT Press, Cambridge, Mass., 1988) which state that for r>d,

$$\frac{{Y}_{l , m} ( {θ}^{′} , {ϕ}^{′} )}{{r}^{′ l + 1}} = {\sum }_{{l}^{′} = 0}^{∞} {\sum }_{{m}^{′} = - {l}^{′}}^{{l}^{′}} {{K}_{{l}^{′} , {m}^{′} . l m} [ \frac{4 π ( 2 l + 1 )}{( 2 {l}^{′} + 1 ) ( 2 {l}^{′} + 2 l + 1 )} ]}^{\frac{1}{2}} {d}^{{t}^{′}} {Y}_{{l}^{′} , {m}^{′}}^{*} ( {θ}_{d} , {ϕ}_{d} ) \frac{{Y}_{{l}^{′} + l , {m}^{′} + m} ( θ , ϕ )}{{r}^{{t}^{′} + l + 1}} \qquad ( 12 )$$

where

$${K}_{{l}^{′} , {m}^{′} , l , m} = {[ \frac{( {l}^{′} + l + {m}^{′} + m ) ! ( {l}^{′} + l - {m}^{′} - m ) !}{( {l}^{′} + {m}^{′} ) ! ( {l}^{′} - {m}^{′} ) ! ( l + m ) ! ( l - m ) !} ]}^{\frac{1}{2}} . \qquad ( 13 )$$

Since a geometry with θ_{d}=0 has been used, only m′=0 terms in Eq. (12) are non-vanishing, in which case Eq. (10) becomes,

$${\sum }_{i} \frac{{q}_{i}}{{ε}_{1} \vert \vec{r} - \vec{{r}_{i}} \vert} = {\sum }_{l = 0}^{∞} {\sum }_{m = - 1}^{ l} \frac{1}{{ε}_{1}} {( \frac{4 π}{2 l + 1} )}^{\frac{1}{2}} {Q}_{l , m}^{′ *} {\sum }_{{l}^{′} = 0}^{∞} {K}_{{l}^{′} , 0 , l , m} {{d}^{{l}^{′}} ( \frac{4 π}{2 {l}^{′} + 2 l + 1} )}^{\frac{1}{2}} \frac{{Y}_{{l}^{′} + l , m} ( θ , ϕ )}{{r}^{{l}^{′} + l + 1}} \qquad ( 14 )$$

in which the multipole distribution was taken about the poi\vec{nt} d, but the potential was expressed as a summation of spherical harmonics about the large-sphere center. The above equation can also be written as,

$${\sum }_{i} \frac{{q}_{i}}{{ε}_{1} \vert \vec{r} - \vec{{r}_{i}} \vert} = {\sum }_{l = 0}^{∞} {\sum }_{m = - 1}^{ l} \frac{1}{{ε}_{1}} {( \frac{4 π}{2 l + 1} )}^{\frac{1}{2}} \frac{{Y}_{l , m} ( θ , ϕ )}{{r}^{l + 1}} {\sum }_{{l}^{′} = [ m ]}^{l } {K}_{l - {l}^{′} , 0 , {l}^{′} , m} {{d}^{l - {l}^{′}} ( \frac{4 π}{2 {l}^{′} + 1} )}^{\frac{1}{2}} {Q}_{{l}^{′} , m}^{′ *} \qquad ( 15 )$$

where terms with the same Y_{l,m}(θ, φ) are grouped together, as opposed to Eq. (14), where terms with the same Q′*_{l,m} are grouped.

Upon substituting Eq. (15) into Eq. (7) and matching boundary conditions at r=R or room temperature,

$$\begin{matrix}{V}_{i n} {\vert}_{r = R} = {V}_{out} {\vert}_{r = R} & ( 16 ) \\ {ε}_{1} \frac{\partial {V}_{i n}}{\partial r} {\vert}_{r = R} = {ε}_{2} \frac{\partial {V}_{out}}{\partial r} {\vert}_{r = R} & ( 17 )\end{matrix}$$

the hydration (reaction-field) potential inside the sphere is,

$$\begin{matrix}{V}_{hyd} ( \vec{r} ) = {\sum }_{l = 0}^{∞} {\sum }_{m = - 1}^{i} {A}_{l , m} {r}^{′} {Y}_{l , m} ( θ , ϕ ) \\ = {\sum }_{l = 0}^{∞} {\sum }_{m = - 1}^{i} {( \frac{4 π}{2 l + 1} )}^{\frac{1}{2}} {r}^{′} {Y}_{l , m} ( θ , ϕ ) ( \frac{\text{?}}{{R}^{2 l + 1}} ) \text{?}\end{matrix}$$

$$\text{?} \text{indicates text missing or illegible when filed}$$

where

$${C}_{i} = \frac{( {ε}_{1} - {ε}_{2} )}{{ε}_{1} [ {ε}_{2} + l {ε}_{1} / ( l + 1 ) ]} . \qquad ( 20 )$$

The various V's can be rewritten, with their dependence on the Q′*_{l,m} made explicit. V′_{coul,L}^{bound} is given by Eq. (20), V_{hyd,l}^{bound} is given by Eq. (19) but rewritten so that the
terms with the same Q′*_{l,m} are collected, and V_{hyd,L}^{unbound} is given by Eq. (19) with R=a and d=0.

$$\begin{matrix}{V}_{coul , L}^{′ bound} ( \vec{{r}^{′}} ) = {\sum }_{l = 0}^{∞} {\sum }_{m = - 1}^{l} \frac{4 π}{2 l + 1} {Q}_{l , m}^{′ *} \frac{{Y}_{l , m} ( {θ}^{′} , {ϕ}^{′} )}{{ε}_{1} {r}^{′l + 1}} & ( 21 ) \\ {V}_{hyd}^{′ bound} ( \vec{r} ) = {\sum }_{l = 0}^{∞} {\sum }_{m = - 1}^{l} {\sum }_{{l}^{′} = 1}^{∞} {( \frac{4 π}{2 l + 1} )}^{\frac{1}{2}} {( \frac{4 π}{2 {l}^{′} + 1} )}^{\frac{1}{2}} {Q}_{l , m}^{′ *} K \text{?} & ( 22 ) \\ {V}_{hyd , L}^{unbound} ( \vec{r} ) = {\sum }_{l = 0}^{∞} {\sum }_{m = - 1}^{l} \frac{4 π}{2 l + 1} ( \frac{{C}_{l}}{{α}^{2 l + 1}} ) {Q}_{l , m}^{′ *} r \text{?} \\ \text{?} \text{indicates text missing or illegible when filed} & ( 23 )\end{matrix}$$

Substituting into Eq. (4), the dependence of ΔG_{int,L-R} on the Q′*_{l,m} is made explicit,

$$\begin{matrix}Δ {G}_{int , L - R} = {\sum }_{j ∈ R} {q}_{j} [ {V}_{coul , L}^{′ bound} ( \vec{{r}_{j}^{′}} ) + {V}_{hyd , L}^{bound} ( \vec{{r}_{j}} ) ] \\ = {\sum }_{l = 0}^{∞} {\sum }_{m = - l}^{l} {Q}_{l , m}^{′ *} {\sum }_{j ∈ R} {q}_{j} [ ( \frac{4 π}{2 l + 1} ) \frac{{Y}_{l , m} ( {θ}_{j}^{′} \cdot {ϕ}_{j}^{′} )}{{ε}_{1} {r}_{j}^{′l + 1}} + \\ {\sum }_{{l}^{′} = l}^{∞} {( \frac{4 π}{2 l + 1} )}^{\frac{1}{2}} {( \frac{4 π}{2 {l}^{′} + 1} )}^{\frac{1}{2}} K \text{?} ( \frac{{C}_{{l}^{′}}}{{R}^{2 {l}^{′} + 1}} ) \\ {r}_{j}^{{l}^{′}} {Y}_{{l}^{′} , m} ( {θ}_{j} , {ϕ}_{j} ) ] \\ ≡ {\sum }_{l = 0}^{∞} {\sum }_{m = - l}^{l} {α}_{l , m} {Q}_{l , m}^{′ *}\end{matrix} \\ \text{?} \text{indicates text missing or illegible when filed} \qquad \begin{matrix}( 24 ) \\ \\ ( 25 ) \\ \\ \\ \\ \\ \\ \\ \\ \\ ( 26 )\end{matrix}$$

where in the last line the element α_{l,m} is defined, which is independent of the Q′*_{l,m}, to be the factor multiplying Q′*_{l/m} in Eq. (25). Each α_{l,m} expresses the contribution of a multipole to ΔG_{int,L-R} and contains all information concerning the antigen charge distribution required to obtain ΔGᵥₐᵣ. For ΔG_{hyd,L} it is useful to re-express Eq. (5) in terms of the Q′*_{l,m}, the multipoles describing the antibody charge distribution, rather than the individual charges, qᵢ.
V(\vec{r}) is expanded around the center of the multipole expansion, \vec{d},

$$\begin{matrix}{\sum }_{i ε L} {q}_{i} V ( \vec{{r}_{i}} ) = {\sum }_{i ε L} {q}_{i} V ( \vec{d} + \vec{{r}_{i}} ) \\ = {\sum }_{i ε L} {q}_{i} [ V ( \vec{d} ) + \vec{{r}_{i}^{′}} \cdot \vec{∇} V ( \vec{d} ) + … ] .\end{matrix} \qquad \begin{matrix}( 27 ) \\ \\ ( 28 )\end{matrix}$$

It has been shown by Rose (M. E. Rose, J. Math. & Phys. 37, 215 (1958); M. E. Rose, Elementary Theory of Angular Momentum (John Wiley and Sons, New York, 1957)) that in spherical coordinates the expansion becomes,

$${\sum }_{i ε L} {q}_{i} V ( \vec{d} + \vec{{r}_{i}} ) = {\sum }_{l = 0}^{∞} {\sum }_{m = - l}^{l} \frac{4 π}{( 2 l + 1 ) !!} {Q}_{l , m}^{′ *} {y}_{l , m} ( \vec{∇} ) V ( \vec{d} ) \qquad ( 29 )$$

where
y_{l,m}(\vec{r})≡r^{l}Y_{l,m}(θ,φ) (30)
and y_{l,m}(\vec{∇}) is the operator obtained by replacing \vec{r} with \vec{∇}.

For positive m and when y_{l,m}(\vec{∇}) operates on a solution of the Laplace equation (i.e. r^{l}Y_{l,m}(θ, φ) or Y_{l,m}(θ, φ)/r^{l+1}), it has been shown that,

$${y}_{l , m} ( \vec{∇} ) = {\frac{( 2 l ) !}{{2}^{′} l !} [ ( \frac{2 l + 1}{4 π} ) \frac{{2}^{m}}{( l + m ) ! ( l - m ) !} ]}^{\frac{1}{2}} {∇}_{L}^{m} {∇}_{G}^{l - m} \\ for m \geq 0. \qquad ( 31 )$$

The double factorial is defined as

$$\begin{matrix}( 2 l + 1 ) !! = ( 2 l + 1 ) \cdot ( 2 l - 1 ) \cdot ( 2 l - 3 ) … 3 \cdot 1 \\ = \frac{( 2 l + 1 ) !}{{2}^{i} l !}\end{matrix} \qquad \begin{matrix}( 32 ) \\ ( 33 )\end{matrix}$$

and the spherical partial derivatives are

$$\begin{matrix}{∇}_{1} = - \frac{1}{\sqrt{2}} ( {∇}_{x} + i {∇}_{y} ) \cdot {∇}_{- 1} \\ = \frac{1}{\sqrt{2}} ( {∇}_{x} - i {∇}_{y} ) \cdot {∇}_{0} \\ = {∇}_{x} .\end{matrix} \qquad ( 34 )$$

To compute y_{l,m}(\vec{∇}) for negative m, the fact that Y_{l,-m}(θ, φ)=(−1)^{m}Y*_{l,m}(θ, φ) is used and the definitions of spherical partial derivatives in Eq. (34) to obtain,

$${y}_{l , - m} ( {∇}^{->} ) = {\frac{( 2 l ) !}{{2}^{l} l !} [ ( \frac{2 l + 1}{4 π} ) \frac{{2}^{m}}{( l + m ) ! ( l - m ) !} ]}^{\frac{1}{2}} {∇}_{- 1}^{m} {∇}_{0}^{l - m} for m \geq 0. \qquad ( 35 )$$

The hydration energy of the bound antibody is then

$$\begin{matrix}\begin{matrix}{G}_{hyd , L}^{bound} = \frac{1}{2} {\sum }_{l ∈ L} {q}_{i} {V}_{hyd , L}^{bound} ( {d}^{->} - {{r}_{l}^{′}}^{->} ) \\ = \frac{1}{2} {\sum }_{{l}^{′} = 0}^{∞} {\sum }_{{m}^{′} = - {l}^{′}}^{{l}^{′}} \frac{4 π}{( 2 {l}^{′} + 1 ) !!} {{Q}_{{l}^{′}}^{′ *}}_{, {m}^{′}} {{y}_{l , {m}^{ ′}}}^{′} ( {∇}^{->} ) {V}_{hyd , L}^{bound} ( {d}^{->} ) \\ = \frac{1}{2} {\sum }_{{l}^{′} = 0}^{∞} {\sum }_{{m}^{′} = - {l}^{′}}^{{l}^{′}} \frac{4 π}{( 2 {l}^{′} + 1 ) !!} {{Q}_{{l}^{′}}^{′ *}}_{, {m}^{′}} {y}_{{l}^{′} , {m}^{ ′}} \\ {\sum }_{l = 0}^{∞} {\sum }_{m = - i}^{l} {\sum }_{{l}^{″} = ℓ}^{∞} {( \frac{4 π}{2 l + 1} )}^{\frac{1}{2}} {( \frac{4 π}{2 {l}^{″} + 1} )}^{\frac{1}{2}} \times \end{matrix} & ( 36 ) \\ {Q}_{l , m}^{′ *} {κ}_{{l}^{″} - l , 0 , l , m} {d}^{{l}^{″} - i} ( \frac{ {C}_{{l}^{ ″}}}{ {R}^{2 {l}^{ ″} + 1}} ) {y}_{{i}^{′} , {m}^{′}} ( {∇}^{->} ) ( {r}^{{l}^{″}} {Y}_{{i}^{″} , m} ( θ , ϕ ) ) {\vert}_{{r}^{->} = {d}^{->}} . & ( 37 )\end{matrix}$$

To evaluate y_{l,m}(\vec{∇}) in Eq. (37), Eq. (31) and the gradient formula are used (M. E. Rose, Elementary Theory of Angular Momentum (John Wiley and Sons, New York, 1957))

$${∇}^{->} ( Φ ( r ) {Y}_{l , m} ( θ , ϕ ) ) = - {( \frac{l + 1}{2 l + 1} )}^{\frac{1}{2}} ( \frac{ⅆ Φ ( r )}{ⅆ r} - \frac{l}{r} Φ ( r ) ) {T}_{l , ℓ + 1 , m} ( θ , ϕ ) + {( \frac{l}{2 ℓ + 1} )}^{\frac{1}{2}} ( \frac{ⅆ Φ ( r )}{ⅆ r} + \frac{l + 1}{r} Φ ( r ) ) {T}_{l , ℓ - 1 , m} ( θ , ϕ ) \qquad ( 38 )$$

where

$${T}_{l , {l}^{′} , m} ( θ , ϕ ) ≡ {\sum }_{{m}^{′} ∈ 1 - 1 , 0 , 1 l} C ( {l}^{′} , 1 , l ; m - {m}^{′} , {m}^{′} ) {Y}_{{l}^{′} , m - {m}^{′}} ( θ , ϕ ) {\hat{ξ}}_{{m}^{′}} \qquad ( 39 )$$

the C(l′, 1,l; m-m′, m′) are the vector addition (or Clebsch-Gordon) coefficients frequently encountered in the study of angular momentum shown in Table 1 (of Rose), and \hat{ξ}ₘ, are spherical unit vectors,

$${\hat{ξ}}_{1} = - \frac{1}{\sqrt{2}} ( \hat{x} + i \hat{y} ) , {\hat{ξ}}_{- 1} = \frac{1}{\sqrt{2}} ( \hat{x} - i \hat{y} ) , {\hat{ξ}}_{0} = \hat{z} . \qquad ( 40 )$$

Accordingly,
\vec{∇}=\hat{x}∇ₓ+ŷ∇_{y}+\hat{z}∇_{z}=−\hat{ξ}₁∇₋₁−\hat{ξ}₋₁∇₁+\hat{ξ}₀∇₀. (41)
From Eqs. (38) through (41),
∇ᵤ(r^{l}Y_{l,m}(θ,φ)=(−1)^{u}[1(2l+1)]^{1/2}C(l−1,1,l;m+u,−u)r^{l-1}Y_{l-1,m+u} (θ(42)
Using Table I, Eq. (31), and Eqs. (37) through (42), the following intermediate results are obtained,

$$\begin{matrix}{∇}_{0}^{{l}^{′} - {m}^{′}} ( {r}^{{l}^{″}} {Y}_{{l}^{″} , m} ) = {[ \frac{( 2 {l}^{″} + 1 ) ( {l}^{″} + m ) ! ( {l}^{″} - m ) !}{\begin{matrix}( 2 {l}^{″} - 2 {l}^{′} + 2 {m}^{′} + 1 ) \\ ( {l}^{″} - m - {l}^{′} + {m}^{′} ) ! \\ ( {l}^{″} + m - {l}^{′} + {m}^{′} ) !\end{matrix}} ]}^{\frac{1}{2}} {r}^{{i}^{″} - {i}^{′} + {m}^{′}} {Y}_{{l}^{″} - {l}^{′} + {m}^{′} , m} & ( 43 ) \\ {∇}_{1}^{{m}^{′}} ( {r}^{{l}^{″} - {l}^{′} + m} {Y}_{{i}^{″} - {l}^{′} + {m}^{′} , m} ) = {{( - 1 )}^{{m}^{′}} [ \frac{\begin{matrix}( 2 {l}^{″} - 2 {l}^{′} + 2 {m}^{′} + 1 ) \\ ( {l}^{″} - m - {l}^{′} + {m}^{′} ) !\end{matrix}}{\begin{matrix}{{2}^{m}}^{′} ( 2 {l}^{″} - 2 {l}^{′} + 1 ) \\ ( {l}^{″} - m - {l}^{′} - {m}^{′} ) !\end{matrix}} ]}^{\frac{1}{2}} {r}^{{i}^{″} - {i}^{′} {Y}_{{l}^{″} - {l}^{′} , m + {m}^{′}}} & ( 44 ) \\ {∇}_{- 1}^{m ′} ( {r}^{{i}^{′′} - {i}^{′} + {m}^{′}} {Y}_{{l}^{′′} - {l}^{′} + {m}^{′} , m} ) = {{( - 1 )}^{{m}^{′}} [ \frac{\begin{matrix}( 2 {l}^{′′} - 2 {l}^{′} + 2 {m}^{′} + 1 ) \\ ( {l}^{′′} + m - {l}^{′} + {m}^{′} ) !\end{matrix}}{\begin{matrix}{2}^{{m}^{′}} ( 2 {l}^{′′} - 2 {l}^{′} + 1 ) \\ ( {l}^{′′} + m - {l}^{′} - {m}^{′} ) !\end{matrix}} ]}^{\frac{1}{2}} {r}^{{i}^{′′} - {i}^{′}} {Y}_{{l}^{′′} - {l}^{′} , m - {m}^{′}} & ( 45 )\end{matrix}$$

and the final expression for the hydration energy of the antibody in the bound state,

$$\begin{matrix}\begin{matrix}{G}_{hyd , L}^{bound} = \frac{1}{2} {\sum }_{i ∈ L} qi {V}_{hyd , L}^{bound} ( {{r}^{->}}_{l}^{′} ) \\ = \frac{1}{2} {\sum }_{i = 0}^{∞} {\sum }_{m = - l}^{i} {\sum }_{{l}^{′} = 0}^{∞} {Q}_{l , m}^{′} {Q}_{{l}^{′} , m}^{′} {\sum }_{{l}^{′′} = max ( l , {i}^{′} )}^{∞} {( \frac{4 π}{2 l + 1} )}^{\frac{1}{2}} \\ {( \frac{4 π}{ 2 {l}^{ ′} + 1} )}^{\frac{1}{2}} \frac{{C}_{{i}^{′′}}}{{R}^{2 {i}^{′′ + 1}} } \times \frac{( {l}^{′} + m ) ! ( {l}^{′′} - m ) !}{( {l}^{′′} - l ) ! ( {l}^{′′} - {l}^{′} ) !} \\ {[ \frac{1}{\begin{matrix}( l + m ) ! ( l - m ) ! \\ ( {l}^{′} + m ) ! ( {l}^{′} - m ) !\end{matrix}} ]}^{\frac{1}{2}} {d}^{2 {i}^{′′}} - l - {l}^{′}\end{matrix} & ( 46 ) \\ ≡ {\sum }_{i = 0}^{∞} {\sum }_{m = - l}^{i} {\sum }_{{i}^{′} = 0}^{∞} {\sum }_{{m}^{′} = - {l}^{′}}^{{l}^{′}} {β}_{l , m , {l}^{′} , {m}^{′}} {Q}_{{i}^{′}}^{′ *} {Q}_{{i}^{′} , m}^{′} & ( 47 )\end{matrix}$$

where β_{l,m,l′,m′} is defined by the above two equations; note that β_{l,m,l′,m′} zero for m′ m.

The hydration energy of the unbound antibody is obtained by setting d=0 and R=α in Eq. (46),

$$\begin{matrix}\begin{matrix}{G}_{hyd , L}^{unbound} = \frac{1}{2} {\sum }_{i ∈ L} qi {V}_{hyd , L}^{unbound} ( {{r}^{->}}_{i}^{′} ) \\ = \frac{1}{2} {\sum }_{i = 0}^{∞} {\sum }_{m = - l}^{i} \frac{4 π}{2 l + 1} ( \frac{{C}_{l}}{{a}^{2 l + 1}} ) {Q}_{i , m}^{′ *} {Q}_{l , m}^{′}\end{matrix} & ( 48 ) \\ ≡ {\sum }_{i = 0}^{∞} {\sum }_{m = - l}^{i} {γ}_{i , m} {Q}_{i , m}^{′ *} {Q}_{i , m}^{′} & ( 49 )\end{matrix}$$

where γ_{l,m} is defined by Eqs. (48) and (49). Then, γ_{l,m} is written as a function of both l and m for notational convenience, although there is no formal dependence on m.

Thus ΔGᵥₐᵣ has been expressed as a function of the multipoles of the antibody charge distribution, Q′_{l,m} (expanded about the center of the antibody sphere) and the elements α_{l,m}, β_{l,m,l′,m′} and γ_{l,m} which do not depend on Q′_{l,m}. Combining Eqs. (26), (47) and (49) gives

$$Δ {G}_{var} = {\sum }_{i = 0}^{∞} {\sum }_{m = - l}^{i} {α}_{i , m} {Q}_{i , m}^{′ *} + {\sum }_{i = 0}^{∞} {\sum }_{m = - l}^{i} {\sum }_{{l}^{′} = 0}^{∞} {\sum }_{{m}^{′} = - {l}^{′}}^{{i}^{′}} {β}_{i , m , {i}^{′} , {m}^{′}} {Q}_{i , m}^{′ *} {Q}_{{i}^{′} , {m}^{′}} - {\sum }_{i = 0}^{∞} {\sum }_{m = 0 l}^{i} {γ}_{i , m} {Q}_{i , m}^{′ *} {Q}_{i , m}^{′} . \qquad ( 50 )$$

Note that only the α_{l,m} depend on the antigen charges, while the β_{l,m,l′,m′} and γ_{l,m} depend solely on the geometry of the bound and unbound states. While ΔGᵥₐᵣ^{opt} is a real quantity, the α_{l,m} and Q′_{l,m} are complex and the products α_{l,m}Q′*_{l,m} and Q′*_{l,m}Q′_{l′,m} involve summations over terms of the form Y*_{l′,m}(θ′, φ′)Y_{l,m}(θ, φ); note that the β_{l,m,l′,m′} and γ_{l,m} are real. Then ΔGᵥₐᵣ^{opt} is rewritten in terms of the real and imaginary parts of α_{l,m} and Q′_{l,m},

$$Δ {G}_{var} = {\sum }_{i = 0}^{∞} [ {α}_{l , 0} {Q}_{i , 0}^{′} + 2 {\sum }_{m = 1}^{i} ( Re {α}_{l , m} Re {Q}_{i , m}^{′} + Im {α}_{i , m} Im {Q}_{i , m}^{′} ) ] + {\sum }_{i = 0}^{∞} {\sum }_{{l}^{′} = 0}^{∞} [ {β}_{i , 0 , {i}^{′} , 0} {Q}_{i , 0}^{′} {Q}_{{i}^{′} , 0}^{′} + 2 {\sum }_{m = 1}^{l} {β}_{i , m , {l}^{′} , m .} ( Re {Q}_{l , m}^{′} Re {Q}_{{l}^{′} , m}^{′} + Im {Q}_{i , m}^{′} Im {Q}_{{i}^{′} , m}^{′} ) ] - {\sum }_{i = 0}^{∞} [ {γ}_{i , 0} {Q}_{i , 0}^{′2} + 2 {\sum }_{m = 1}^{i} {γ}_{i , m} ( Re {Q}_{i , m}^{′2} + Im {Q}_{i , m}^{′2} ) ] \qquad ( 51 )$$

(where summations over m are excluded for l=0) by noting again that Y_{l,-m}(θ, φ)=(−1)^{m}Y*_{l,m}(θ, φ) and

$$\begin{matrix}{Y}_{l , m}^{*} ( {θ}^{′} , {ϕ}^{′} ) {Y}_{l , m} ( θ , ϕ ) + {Y}_{{l}^{′} , - m}^{*} ( {θ}^{′} , {ϕ}^{′} ) {Y}_{l , - m} ( θ , ϕ ) = {Y}_{{l}^{′} , m}^{*} ( {θ}^{′} , {ϕ}^{′} ) {Y}_{l , m} ( θ , ϕ ) + {Y}_{{l}^{′} , m} ( {θ}^{′} , {ϕ}^{′} ) {Y}_{l , m}^{*} ( θ , ϕ ) & ( 52 ) \\ = 2 [ Re {Y}_{{l}^{′} , m} ( {θ}^{′} , {ϕ}^{′} ) \cdot {Re Y}_{l , m} ( θ , ϕ ) + {Im Y}_{{l}^{′} , m} ( {θ}^{′} , {ϕ}^{′} ) \cdot {Im Y}_{l , m} ( θ , ϕ ) ] . & ( 53 )\end{matrix}$$

The new variables ReQ′_{l,m} and ImQ′_{l,m} are re-indexed and renamed Qᵢ as follows,
{Q′_{0,0},Q′_{1,0},ReQ′_{1.1},ImQ′_{1,1},Q′_{2,0},ReQ′_{2,1},ImQ′_{2,1}, ReQ′_{2,2}, . . . } [symbol] {Q₁,Q₂, Q₃,Q₄,Q₅,Q₆,Q₇,Q₈, . . . }. (54)
and similar transformations are used to create αᵢ, βᵢⱼ, and γᵢ. Eq. (51) can then be written as

$$\begin{matrix}Δ {G}_{var} = {\sum }_{i = 1}^{∞} {α}_{i} {Q}_{i} + {\sum }_{i = 1}^{∞} {\sum }_{j = 1}^{∞} {β}_{ij} {Q}_{i} {Q}_{j} - {\sum }_{i = 1}^{∞} {γ}_{i} {Q}_{i}^{2} \\ = {\sum }_{i = 1}^{∞} {α}_{i} {Q}_{i} + {\sum }_{i = 1}^{∞} {\sum }_{j = 1}^{∞} ( {β}_{ij} - {δ}_{ij} {γ}_{i} ) {Q}_{i} {Q}_{j}\end{matrix} \qquad \begin{matrix}( 55 ) \\ ( 56 )\end{matrix}$$

or in matrix notation,

$$\begin{matrix}Δ {G}_{var} = {{Q}^{->}}^{T } \overleftrightarrow{B} {Q}^{->} + {{Q}^{->}}^{T} {A}^{->} \\ = {( {Q}^{->} + \frac{1}{2} {\overleftrightarrow{B}}^{- 1} {A}^{->} )}^{T} \overleftrightarrow{B} ( {Q}^{->} + \frac{1}{2} {\overleftrightarrow{B}}^{- 1} {A}^{->} ) - \frac{1}{4} {{A}^{->}}^{T} {\overleftrightarrow{B}}^{- 1} {A}^{->}\end{matrix} \qquad \begin{matrix}( 55 ) \\ ( 56 )\end{matrix}$$

where \vec{Q} is the vector formed by the Qᵢ, \vec{A} is the vector formed by the αᵢ, [symbol] is the symmetric matrix formed by the (βᵢⱼ−δᵢⱼ γᵢ), and completion of the square has been used to arrive at Eq. (58). Since
\vec{Q}^{T} [symbol] \vec{Q} in Eq. (57) corresponds to the antibody desolvation penalty, which must be greater than zero for chemically reasonable geometries, the matrix [symbol] is positive definite and the extreme of ΔGᵥₐᵣ is a minimum (G. Strang, Introduction to Applied Mathematics (Wellesley-Cambridge Press, Wellesley, Mass., 1986).

From Eq. (58) the optimum values of the multipoles, \vec{Q}^{opt} and the minimum variational binding energy, ΔGᵥₐᵣ^{opt} are obtained,

$$\begin{matrix}{{Q}^{->}}^{opt} = - \frac{1}{2} {\overleftrightarrow{B}}^{- 1} {A}^{->} & ( 59 ) \\ Δ {G}_{var}^{opt} = - \frac{1}{4} {{A}^{->}}^{T} {\overleftrightarrow{B}}^{- 1} {A}^{->} . & ( 60 )\end{matrix}$$

ΔGᵥₐᵣ^{opt} is always negative because [symbol] ⁻¹ is also positive definite.

To solve for the optimal multipole distribution with the monopole (total charge) fixed (Q₁= [symbol] ), the equation for the remaining optimal multipoles (i≠1) is,

$$2 {\sum }_{j \neq 1} ( {β}_{ij} - {δ}_{ij} {γ}_{l} ) {Q}_{j}^{opt} + ( 2 {β}_{il} Q + {α}_{l} ) = 0 \qquad ( 61 )$$

which is analogous to Eq. (59).

The above matrix equations, with the dimension truncated at iₘₐₓ=(lₘₐₓ+1)², can be solved numerically by relatively modest computational resources. In practice, since the αᵢ and βᵢⱼ, contain a summation over an infinite number of terms, a second cutoff value of l_{cut} must be used to truncate the innermost sum in Eqs. (25) and (46). When lₘₐₓ and l_{cut} are sufficiently large, ΔGᵥₐᵣ^{opt} converges and the incremental advantage of including more multipoles essentially vanishes.

For any given antigen and geometry, the present description has thus described a method to determine the charge distribution of the tightest binding antibody as a set of multipoles. The deviation of the binding free energy from the optimum for any test antibody

can be calculated by subtracting Eq. (60) from Eq. (58) and using Eq. (59) to eliminate \vec{A},

TABLE 1
Vector Addition Coefficients
C(1′, 1, l; m − m′, m′),^{a}

| | m′ = 1 | m′ = 0 | m′ = −1 |
|---|---|---|---|
| 1 = 1′ + 1 | ${[ \frac{( {1}^{′} + m ) ( {1}^{′} + m + 1 )}{( {21}^{′} + 1 ) ( {21}^{′} + 2 )} ]}^{1 / 2}$ | ${[ \frac{( {1}^{′} - m + 1 ) ( {1}^{′} + m + 1 )}{( {21}^{′} + 1 ) ( {1}^{′} + 1 )} ]}^{1 / 2}$ | ${[ \frac{( {1}^{′} - m ) ( {1}^{′} - m + 1 )}{( {21}^{′} + 1 ) ( {21}^{′} + 2 )} ]}^{1 / 2}$ |
| 1 = 1′ | ${[ \frac{( {1}^{′} + m ) ( {1}^{′} - m + 1 )}{{21}^{′} ( {1}^{′} + 1 )} ]}^{1 / 2}$ | $\frac{m}{{[ {1}^{′} ( {1}^{′} + 1 ) ]}^{1 / 2}}$ | ${[ \frac{( {1}^{′} - m ) ( {1}^{′} + m + 1 )}{{21}^{′} ( {1}^{′} + 1 )} ]}^{1 / 2}$ |
| 1 = 1′ − 1 | ${[ \frac{( {1}^{′} - m ) ( {1}^{′} - m + 1 )}{{21}^{′} ( {21}^{′} + 1 )} ]}^{1 / 2}$ | ${[ \frac{( {1}^{′} - m ) ( {1}^{′} + m )}{{1}^{′} ( {21}^{′} + 1 )} ]}^{1 / 2}$ | ${[ \frac{( {1}^{′} + m + 1 ) ( {1}^{′} + m )}{{21}^{′} ( {21}^{′} + 1 )} ]}^{1 / 2}$ |

^{a}from reference 4

### EXAMPLE 1

### Methods of Improving the Antigen-Binding Affinity of an Anti-Integrin Antibody

In this example, methods for improving the binding affinity of an antibody against a therapeutically relevant antigen target, are described.

As proof-of-principle, the method of the invention was applied to an antibody against VLA-1 integrin, a cell-surface receptor for collagen and laminin, and in particular, the monoclonal antibody AQC2, which was raised against the human VLA-1 receptor by affinity maturation in mice. AQC2 inhibits the pathological processes mediated by VLA-1 integrin (see, e.g., WO 02/083854).

A variant of ACQ2 with two mutations binds to VLA-1 with 100-fold less affinity than the wild-type antibody. In an effort to restore this binding, electrostatic charge optimization techniques were applied to a crystal structure of the antibody-antigen complex in a two-level procedure to suggest improved-affinity mutants. First, electrostatic charge optimization was used to determine the position(s) of the CDR residue(s) that are sub-optimal for binding (Lee and Tidor, J. Chem. Phys. 106:8681-8690, 1997; Kangas and Tidor, J. Chem. Phys. 109:7522-7545, 1998). Second, a set of CDR mutations were then determined for further computational analysis. Based on these calculations, the binding affinity was determined for 36 modified antibodies having a single mutation (i.e., 36 “single mutants”) and 10 antibodies having two mutations (i.e., ten “double mutants”). It was predicted that 26 of the single mutants would be electrostatically favorable relative to the wild-type antibody, and that 15 would bind better with a full energy function including a van der Waals energy term and a solvent accessible surface area term. These terms are unrelated to electrostatic forces, but they were calculated to ensure that the designed mutations did not contact other residues and would not reduce the amount of buried surface area significantly; increased buried surface area in complex formation is usually beneficial (see the “Full Energy” column of the table below). Additionally, it was predicted that many of the double mutants would be more favorable than the wild-type complex and that the effects would be partially additive with respect to the single mutants.

The mutation predictions can be categorized as involving (1) mutations at the interaction interface involving residues that become partially buried upon binding (interactions are improved by making hydrogen bonds with the antibody); (2) mutations of polar residues on the antibody that become buried upon binding and thus pay a desolvation penalty but do not make any direct electrostatic interactions with the antibody (improvements are usually made by mutation to a hydrophobic residue with similar shape to the wild-type residue or by adding a residue that can make favorable electrostatic interactions); and (3) mutations of surface residues on the antibody that are in regions of uncomplementary potentials. These mutations are believed to improve long-range electrostatic interactions between the antibody and antigen without perturbing packing interactions at the binding interface.

Based on results from a charge optimization, mutations were determined for computational analysis (the optimal charge distributions and design mutations that were closer to optimal than the current residue were examined; this process was done by inspection). A charge optimization gave charges at atom centers but did not yield actual mutation(s). A round of charge optimizations was performed with various constraints imposed to represent natural side chain characteristics. For example, an optimization was performed for a net side chain charge of −1, 0, and +1 with the additional constraint that no atom's charge exceeded an absolute value of 0.85 electron charge units.

The crystal structure of the VLA-1/AQC2 complex (PDB code: 1 MHP) was prepared using standard procedures for adding hydrogens with the program CHARMM (Accelrys, Inc., San Diego, Calif.). N-acetamide and N-methylamide patches were applied to the N termini and C-termini, respectively. There was missing density for residues 288-293 in one of the complexes (Model 1), but no attempt was made to rebuild the density. Using a continuum electrostatics model, an electrostatic charge optimization was performed on each side chain of the amino acids in the CDRs of the ACQ2 antibody. Appropriate side chain mutations were then determined based on the potential gain in electrostatic binding energy observed in the optimizations. Side chains were built by performing a rotamer dihedral scan in CHARMM, using dihedral angle increments of 60 degrees, to determine the most desirable position for each side chain. Binding energies were then calculated for the wild type and mutant complexes using the Poisson-Boltzmann electrostatic energy and additional terms for the van der Waals energy and buried surface area.

The crystal structure of the α1 integrin I-domain (VLA-1) complexed with the Fab fragment of a humanized neutralizing antibody (AQC2) was solved to 2.8 Å at a pH of 7.40. There were two complexes within the asymmetric unit cell. A manganese (MN) atom was at the complex interface in both complexes, with most of its interactions coming from the I-domain. Asp101 from the antibody mimics a collagen glutamate interaction.

The following table shows the optimization results obtained for CDR variable loop 2 in the heavy chain of AQC2. The Mut (Mutation energy) column corresponds to the binding free energy difference (in kcal/mol) in going from the native residue to a completely uncharged sidechain isostere, i.e., a residue with the same shape but no charges or partial charges on the atoms. Negative numbers indicate a predicted increase of binding affinity. The Opt-1 column corresponds to the binding free energy difference that can be obtained with an optimal charge distribution in the side chain and a net side chain charge of −1. The columns Opt0 and Opt1 correspond to the binding free energy differences with optimal charges, the net charge being 0 and +1, respectively. Based on these results and the visual inspection of the structure, mutations are designed that can take advantage of these binding free energy improvements. For instance, the mutation from THR50 to VAL, which is an uncharged isostere, makes use of the predicted −0.52 kcal/mol in the mutation energy. The mutation LYS64 to GLU uses the −1.42 kcal/mol predicted maximal free energy gain for a mutation to a side chain with a net charge of −1.

The selection of mutant designs were further explored computationally according to the following rules.

For example, in those instances in which mutation energy (Mut, corresponding to the binding free energy difference (in kcal/mol) associated with a transition from the native residue to a completely uncharged side chain isostere, i.e., a residue with the same shape but no charges or partial charges on the atoms) was modeled to be favorable (e.g., ΔG<−0.25 kcal/mol), mutations from the set of amino acids with nonpolar sidechains, e.g., Ala, Cys, Ile, Leu, Met, Phe, Pro, Val were selected.

Where Opt−1 energy (corresponding to the binding free energy difference that can be obtained with an optimal charge distribution in the side chain and a net side chain charge of −1) was favorable (e.g., ΔG<−0.25 kcal/mol), mutations from the set of amino acids with negatively charged side chains, e.g., Asp, Glu were selected.

Similarly, where Opt+1 energy (corresponding to the binding free energy difference that can be obtained with an optimal charge distribution in the side chain and a net side chain charge of +1) was favorable (e.g., ΔG<−0.25 kcal/mol), mutations from the set of amino acids with positively charged sidechains, e.g., Arg, His, Lys were selected.

Finally, in those cases in which Opt0 energy (corresponding to the binding free energy difference that can be obtained with an optimal charge distribution in the side chain and a net side chain charge of 0) was favorable (e.g., ΔG<−0.25 kcal/mol), mutations from the set of amino acids with uncharged polar sidechains, e.g., Asn, Cys, Gin, Gly, His, Met, Phe, Ser, Thr, Trp, Tyr, to which are added Cys, Gly, Met and Phe were selected.

TABLE 2
Optimization results obtained for AQC2
CDR heavy chain variable loop 2

| Number | Residue | Mut | Opt-1 | Opt0 | Opt1 |
|---|---|---|---|---|---|
| 50 | THR | −0.52 | 0.3 | −1.24 | 3.17 |
| 51 | ILE | 0 | −1.05 | −0.91 | −0.56 |
| 52 | SER | 0.39 | 6.33 | −0.09 | 1.77 |
| 53 | GLY | — | — | — | — |
| 54 | GLY | — | — | — | — |
| 55 | GLY | — | — | — | — |
| 56 | HSD | −0.2 | −0.09 | −0.68 | −0.02 |
| 57 | THR | 0.05 | −0.77 | −0.61 | −0.3 |
| 58 | TYR | −0.13 | −1.98 | −1.37 | 3.06 |
| 59 | TYR | 0.03 | −1.35 | −0.91 | −0.39 |
| 60 | LEU | 0 | −1.39 | −1.08 | −0.71 |
| 61 | ASP | 0.56 | −0.11 | 0.25 | 0.64 |
| 62 | SER | 0.01 | −0.21 | −0.08 | 0.08 |
| 63 | VAL | 0 | −0.98 | −0.73 | −0.36 |
| 64 | LYS | −0.55 | −1.42 | −1.23 | −0.97 |

As described before, the designed mutants are built in silico and the binding energy is recalculated. Results from these computational mutation calculations are shown below. Numbers represent change in binding affinity from wild-type to the mutant (negative meaning mutant is more favorable). Energies are the average of the two models.

TABLE 3
Computational mutation calculations for AQC2 CDRs

| | | | |
|---|---|---|---|
| Mutation | Electrostatics | Full Energy | Type |

Heavy Chain Modifications

| | | | |
|---|---|---|---|
| Asp106Asn | −0.1 | −0.1 | 3 |
| Arg31Gln | −2.2 | 2.3 | 1 |
| Arg31Glu | −0.8 | 4.9 | 1 |
| Arg31Lys | 0.5 | 2.7 | 1 |
| Arg31Phe | 0.9 | 2.8 | 2 |
| Tyr32Phe | −0.4 | 0.6 | 2 |
| Ser35Asn | −1.3 | −1.3 | 2 |
| Ser35Gln | −0.6 | −0.7 | 2 |
| Thr50Val | −1.2 | −1.7 | 2 |
| His56Phe | −0.8 | −0.8 | 2 |
| Tyr58Asn | −0.3 | 5.1 | 3 |
| Tyr58Asp | −2.0 | 3.2 | 3 |
| Tyr58Gln | −2.4 | 2.1 | 3 |
| Tyr58Glu | −1.2 | 3.1 | 3 |
| Tyr59Asp | −0.6 | −0.6 | 3 |
| Try59Glu | −0.5 | −0.5 | 3 |
| Leu60Asp | −0.1 | −0.1 | 3 |
| Leu60Glu | −0.3 | −0.3 | 3 |
| Lys64Asn | −0.6 | −0.5 | 3 |
| Lys64Asp | −0.9 | −0.8 | 3 |
| Lys64Gln | −0.6 | −0.5 | 3 |
| Lys64Glu | −0.9 | −0.9 | 3 |

Light Chain Modifications

| | | | |
|---|---|---|---|
| Asn30Ala | −0.1 | 1.1 | 2 |
| Asn30Ile | 0.5 | 0.2 | 2 |
| Asn30Leu | −0.3 | −0.5 | 2 |
| Asn30Val | −0.5 | −0.2 | 2 |
| His31Arg | 1.6 | 1.9 | 1 |
| His31Lys | −0.7 | 1.3 | 1 |
| Leu49Arg | 1.0 | 0.0 | 1 |
| Leu49His | 2.4 | 0.6 | 1 |
| Leu49Lys | −0.1 | −1.1 | 1 |
| Asn52Arg | 0.1 | 0.1 | 1 |
| Asn52His | 2.8 | −0.2 | 1 |
| Asn52Lys | 0.3 | 1.5 | 1 |
| Trp95Asp | 2.5 | 4.4 | 3 |
| Trp95Glu | 0.7 | 2.9 | 3 |

As the results show, the computational process described above was successfully implemented to predict affinity enhancing side chain mutations. These findings were classified into three general classes of mutations. The first type of mutation involves residues at the interface across from a charged group on the antigen capable of making a hydrogen bond; the second involves buried polar residues that pay a desolvation penalty upon binding but do not make back electrostatic interactions; and the third involves long-range electrostatic interactions.

The first type of mutation is determined by inspection of basic physical/chemical considerations, as these residues essentially make hydrogen bonds with unsatisfied hydrogen partners of the antigen. Surprisingly, it was observed that the cost of desolvation seemed to outweigh the beneficial interaction energy in most cases. The second type of mutation represents a less intuitive type or set of mutations, as the energy gained is primarily a result of eliminating an unfavorable desolvation while maintaining non-polar interactions. The third mutation type concerns long-range interactions that show potential for significant gain in affinity. These types of mutations are particularly interesting because they do not make direct contacts with the antigen and should, therefore, pose less of a perturbation in the delicate interactions at the antibody-antigen interface.

In accordance with the computational data obtained as described above, mutants of ACQ2 (single chain Fv mutants) were generated, and their affinity was measured by the KinExA™ assay described above. The mutants generated to date are shown in the table that follows. Where an affinity assay has been conducted, the results are shown in the column headed “Kd.” The affinity of the original ACQ2 single chain Fv was 25 nM.

TABLE 4
Observed affinity values for AQC2 altered antibodies

| | |
|---|---|
| Mutant | Kd |

Heavy Chain Modifications

| | | |
|---|---|---|
| R31Q | 8.2 | nM |
| Y32F | 34 | nM |
| S35N | 39 | nM |
| S35Q | 37 | nM |
| T50V | 14 | nM |
| L60D | 21 | nM |
| K64E | 38 | nM |
| K64Q | 12 | nM |
| K64D | 6.3 | nM |
| K64N | 4.1 | nM |
| D106N | 67 | nM |

Light Chain Modifications

| | | |
|---|---|---|
| N30V | 8.9 | nM |
| H31R | 31 | nM |
| N52K | 49 | nM |
| N52R | 17 | nM |
| N52H | 43 | nM |

The following alterations in AQC2 were also made: heavy chain modifications R31K, R31F, R31E, H₅₆F, Y58E, Y58Q, Y59D, Y59E, L60E; light chain mutations N30L, N30A, N30I, H31K, L49K, L49R, L49H, W95E, W95D.

### EXAMPLE 2

### Methods of Improving the Antigen-Binding Affinity of an Anti-CD154 Antibody

In this example, methods for improving the binding affinity of an antibody against a therapeutically relevant antigen target, are described.

An antibody against human CD154 (also known as CD40 ligand or CD40L; see, e.g., Yamada et al., Transplantation, 73:S36-9 (2002); Schonbeck et al., Cell. Mol. Life Sci. 58:4-43 (2001); Kirk et al., Philos. Trans. R. Soc. Lond. B. Sci. 356:691-702 (2001); Fiumara et al., Br. J. Haematol. 113:265-74 (2001); and Biancone et al., Int. J. Mol. Med. 3(4):343-53 (1999)) which is a member of TNF family of proteins involved in mediating immunological responses, was raised by affinity maturation in mice. The 5c8 monoclonal antibody was developed from such studies and determined to inhibit the pathological processes mediated by CD154/CD40L.

In an effort to increase the affinity 5c8/CD40L interaction, electrostatic charge optimization techniques were applied to a crystal structure of the antibody-antigen complex in a two-level procedure to suggest improved-affinity mutants. First, electrostatic charge optimization was used to determine the position(s) of the CDR residue(s) that are sub-optimal for binding (Lee and Tidor, J. Chem. Phys. 106:8681-8690, 1997; Kangas and Tidor, J. Chem. Phys. 109:7522-7545, 1998). Second, a set of CDR mutations were determined for further computational analysis. Based on these calculations, the binding affinity was computationally determined for 23 modified antibodies having a single mutation (i.e., 23 “single mutants”). It was predicted that 8 of the single mutants would be more favorable than wild-type antibody both in terms of electrostatic energy, and in terms of full energy function including a van der Waals energy term and a solvent accessible surface area term. These terms are unrelated to electrostatic forces, but they were calculated to ensure that the designed mutations did not contact other residues and would not reduce the amount of buried surface area significantly; increased buried surface area in complex formation is usually beneficial (see the “Full Energy” column of the table below).

The mutation predictions can be categorized as involving (1) mutations at the interaction interface involving residues that become partially buried upon binding (interactions are improved by making hydrogen bonds with the antibody); (2) mutations of polar residues on the antibody that become buried upon binding and thus pay a desolvation penalty but do not make any direct electrostatic interactions with the antibody (improvements are usually made by mutation to a hydrophobic residue with similar shape to the wild-type residue or by adding a residue that can make favorable electrostatic interactions); and (3) mutations of surface residues on the antibody that are in regions of uncomplementary potentials. These mutations are believed to improve long-range electrostatic interactions between the antibody and antigen without perturbing packing interactions at the binding interface.

Based on results from a charge optimization, mutations were determined for computational analysis (the optimal charge distributions and design mutations that were closer to optimal than the current residue were examined; this process was done by inspection). A charge optimization gave charges at atom centers but did not yield actual mutation. A round of charge optimizations was performed with various constraints imposed to represent natural side chain characteristics. For example, an optimization was performed for a net side chain charge of −1, 0, and +1 with the additional constraint that no atom's charge exceeded an absolute value of 0.85 electron charge units.

The crystal structure of the CD40L/5c8 complex (PDB code: 1I9R) was prepared using standard procedures for adding hydrogens with the program CHARMM (Accelrys, Inc., San Diego, Calif.). N-acetamide and N-methylamide patches were applied to the N termini and C-termini, respectively. Using a continuum electrostatics model, an electrostatic charge optimization was performed on each side chain of the amino acids in the CDRs of the ACQ2 antibody. Appropriate side chain mutations were then determined based on the potential gain in electrostatic binding energy observed in the optimizations. Side chains were built by performing a rotamer dihedral scan in CHARMM, using dihedral angle increments of 60 degrees, to determine the most desirable position for each side chain. Binding energies were then calculated for the wild type and mutant complexes using the Poisson-Boltzmann electrostatic energy and additional terms for the van der Waals energy and buried surface area.

The crystal structure of the CD40 ligand complexed with the Fab fragment of a humanized neutralizing antibody (5c8) was solved to 3.1 Å at a pH of 6.50. Since CD40L is naturally a trimer, there are three 5c8 Fab molecules and 5 CD40L molecules in the complex. They form three independent CD40L/5c8 interfaces in the complex. A zinc (ZN) atom was bound to each of the 5c8 Fab and it was included into the calculation. Calculations were carried out independently for three interfaces and the amino acid substitutions that were found to be favorable over wild type for all three sites were exploited.

The following table shows the optimization results obtained for CDR variable loop 1 in the light chain of 5c8 for all three 5c8 molecules. The Mut (Mutation energy) column corresponds to the binding free energy difference (in kcal/mol) in going from the native residue to a completely uncharged sidechain isostere, i.e., a residue with the same shape but no charges or partial charges on the atoms. Negative numbers indicate a predicted increase of binding affinity. The Opt−1 column corresponds to the binding free energy difference that can be obtained with an optimal charge distribution in the side chain and a net side chain charge of −1. The columns Opt0 and Opt1 correspond to the binding free energy differences with optimal charges, the net charge being 0 and +1, respectively. Based on these results and the visual inspection of the structure, mutations are designed that could take advantage of these binding free energy improvements. For instance, the mutation from SER 31 to VAL, which is an uncharged isostere, makes use of the predicted −1.23 to −0.98 kcal/mol in the mutation energy. The mutation GLN 27 to GLU uses the −1.21 to −0.88 kcal/mol predicted maximal free energy gain for a mutation to a side chain with a net charge of −1.

TABLE 5
Optimization results obtained for 5c8
CDR light chain variable loop 1

| | | | | |
|---|---|---|---|---|
| Chain Residue | Mut | Opt-1 | Opt0 | Opt1 |

| | | | | |
|---|---|---|---|---|
| 1L 24 ARG | −0.11 | 0.17 | −0.11 | −0.37 |
| 1L 26 SER | −0.06 | −0.59 | −0.06 | 0.57 |
| 1L 27 GLN | 0.21 | −1.21 | −0.95 | −0.26 |
| 1L 28 ARG | 0.11 | −0.96 | −0.71 | −0.40 |
| 1L 30 SER | −0.01 | −0.14 | −0.42 | −0.47 |
| 1L 31 SER | −1.23 | 3.88 | −2.16 | −0.42 |
| 1L 32 SER | 1.45 | 0.91 | −0.65 | −0.67 |
| 1L 33 THR | −0.02 | −0.66 | −0.41 | 0.07 |
| 1L 34 TYR | −0.25 | −1.00 | −1.10 | −0.80 |
| 1L 35 SER | −0.02 | 0.00 | −0.11 | 0.04 |
| 1L 36 TYR | 0.01 | −0.95 | −1.31 | 1.74 |
| 1L 38 HSD | −0.15 | −0.48 | −0.70 | −0.62 |
| 2L 24 ARG | −0.46 | −1.04 | −0.46 | 0.13 |
| 2L 26 SER | −0.29 | −1.60 | −0.79 | 0.19 |
| 2L 27 GLN | 0.26 | −0.88 | −0.41 | 0.35 |
| 2L 28 ARG | −0.59 | −0.94 | −0.46 | 0.08 |
| 2L 30 SER | 0.08 | −0.38 | −0.55 | −0.42 |
| 2L 31 SER | −0.98 | 4.04 | −1.89 | −0.54 |
| 2L 32 SER | 0.74 | 2.31 | −0.86 | −0.87 |
| 2L 33 THR | 0.00 | −0.65 | −0.38 | 0.09 |
| 2L 34 TYR | −0.09 | −0.62 | −0.48 | −0.12 |
| 2L 35 SER | 0.09 | 0.02 | 0.09 | 0.18 |
| 2L 36 TYR | 0.10 | −1.70 | −1.24 | 2.37 |
| 2L 38 HSD | −0.23 | −1.20 | −1.17 | −0.79 |
| 3L 24 ARG | −0.35 | −0.34 | −0.35 | −0.35 |
| 3L 26 SER | −0.27 | −1.23 | −0.53 | 0.27 |
| 3L 27 GLN | 0.11 | −1.07 | −0.71 | −0.08 |
| 3L 28 ARG | −0.30 | −0.85 | −0.30 | 0.15 |
| 3L 30 SER | 0.03 | 0.02 | −0.29 | −0.36 |
| 3L 31 SER | −1.06 | 4.02 | −2.03 | −0.90 |
| 3L 32 SER | 0.82 | 1.18 | −0.85 | −1.05 |
| 3L 33 THR | 0.20 | −0.32 | −0.15 | 0.29 |
| 3L 34 TYR | 0.09 | −0.80 | −0.74 | −0.38 |
| 3L 35 SER | 0.06 | −0.05 | −0.10 | −0.02 |
| 3L 36 TYR | 0.04 | −0.99 | −1.30 | 1.66 |
| 3L 38 HSD | −0.20 | −0.46 | −0.76 | −0.72 |

As described before, the designed mutants were built in silico and the binding energy was recalculated. Results from these computational mutation calculations are shown below. Numbers represent change in binding affinity from wild-type to the mutant (negative meaning mutant is more favorable). Energies for all three chains of 5c8 are given.

TABLE 6
Computational mutation calculations for 5c8 CDRs

| Chain Mutant | Full Energy | Electrostatics |
|---|---|---|
| 1H TYR33PHE | 0.197 | −2.741 |
| 1H ASN59ASP | −0.995 | −2.548 |
| 1H ASN59LEU | −1.294 | −2.517 |
| 1L SER26ASP | −0.703 | −0.712 |
| 1L GLN27GLU | −0.514 | −0.357 |
| 1L SER31VAL | 8.154 | −1.739 |
| 1L THR33ASP | −0.219 | −0.916 |
| 1L TYR54GLU | −0.999 | −0.729 |
| 2H TYR33PHE | 0.623 | −2.726 |
| 2H ASN59ASP | −0.218 | −2.885 |
| 2H ASN59LEU | −1.116 | −3.067 |
| 2L SER26ASP | −1.333 | −1.627 |
| 2L GLN27GLU | −0.658 | −0.395 |
| 2L SER31VAL | 9.293 | −0.832 |
| 2L THR33ASP | −0.430 | −1.359 |
| 2L TYR54GLU | −1.012 | −1.030 |
| 3H TYR33PHE | 0.145 | −1.979 |
| 3H ASN59ASP | −0.837 | −2.267 |
| 3H ASN59LEU | −1.179 | −2.271 |
| 3L SER26ASP | −0.540 | −0.565 |
| 3L GLN27GLU | −0.497 | −0.342 |
| 3L SER31VAL | 8.129 | −1.284 |
| 3L THR33ASP | −0.337 | −0.676 |
| 3L TYR54GLU | −1.123 | −0.825 |

As the results show, the computational process described above was successfully implemented to predict affinity enhancing side chain mutations. These findings have been classified into three general classes of mutations. The first type of mutation involves residues at the interface across from a charged group on the antigen capable of making a hydrogen bond; the second involves buried polar residues that pay a desolvation penalty upon binding but do not make back electrostatic interactions; and the third involves long-range electrostatic interactions.

The first type of mutation was resolved by inspection, as these residues essentially make hydrogen bonds with unsatisfied hydrogen partners of the antigen. Surprisingly, the cost of desolvation seemed to outweigh the beneficial interaction energy in most cases. The second type of mutation represents a less intuitive type or set of mutations, as the energy gained is primarily a result of eliminating an unfavorable desolvation while maintaining non-polar interactions. The third mutation type concerns long-range interactions that show potential for significant gain in affinity. These types of mutations are particularly interesting because they do not make direct contacts with the antigen and, therefore, pose less of a perturbation in the delicate interactions at the antibody-antigen interface.

In accordance with the computational data obtained as described above, mutants of 5c8 (Fab fragments) were generated, and their affinity towards CD40L was measured by the KinExA™ assay described above. Selected results of some of the mutants generated to date are shown in the table that follows. Where an affinity assay has been conducted, the results are shown in the column headed “IC50.” The affinity of the original 5c8 Fab to CD40L was 0.81 nM.

TABLE 7
Observed affinity values for 5c8 altered antibodies

| Mutant | |
|---|---|
| Light | IC50 |
| S26D | 0.26 nM |
| Q27E | 0.12 nM |

Accordingly, it was concluded that the methods of the invention allow for the affinity maturation of a an antibody of therapeutic relevance.

### EQUIVALENTS

For one skilled in the art, using no more than routine experimentation, there are many equivalents to the specific embodiments of the invention described herein. Such equivalents are intended to be encompassed by the following claims.

1. A method of modulating the antigen-binding affinity of an antibody comprising,
determining a spatial representation of an optimal charge distribution of the amino acids of the antibody and associated change in binding free energy of the antibody when bound to an antigen in a solvent;
identifying at least one candidate amino acid residue position of the antibody to be modified to alter the binding free energy of the antibody when bound to the antigen; and
selecting an elected amino acid residue for substitution for said amino acid position,
such that upon substitution, the antigen-binding affinity of the antibody is modulated.

2. The method of claim 1, further comprising substituting the elected amino acid residue at the candidate amino acid residue position.

3. A method of modulating the antigen-binding affinity of an antibody comprising,
determining a spatial representation of an optimal charge distribution of the amino acids of the antibody and associated change in binding free energy of the antibody when bound to an antigen in a solvent;
identifying at least one candidate amino acid residue position of the antibody to be modified to alter the binding free energy of the antibody when bound to the antigen;
selecting an alteration for said amino acid position,
such that upon alteration, the antigen-binding affinity of the antibody is modulated.

4. The method of claim 3, wherein the alteration is selected from the group consisting of a deletion, an insertion, and an alteration of side chain chemistry.

5. The method of claim 3, further comprising calculating the change in the free energy of binding of the antibody containing the modified amino acid or alteration when bound to the antigen, as compared to the unmodified antibody when bound to the antigen.

6. The method of claim 5, wherein the calculating step first comprises modeling the modification or alteration of the antibody in silico, and then calculating the change in free energy of binding.

7. The method of claim 6, wherein the calculating step uses at least one determination selected from the group consisting of a determination of the electrostatic binding energy using a method based on the Poisson-Boltzmann equation, a determination of the van der Waals binding energy, and a determination of the binding energy using a method based on solvent accessible surface area.

8. The method of claim 3, further comprising expressing the modified or altered antibody.

9. The method of claim 3, wherein the modulation is selected from the group consisting of an increase in antibody/antigen binding affinity and a decrease in antibody/antigen binding affinity.

10. The method of claim 1, wherein the elected amino acid is from a subset of amino acids having characteristic side chain chemistry, said subset of amino acids selected from the group consisting of uncharged polar amino acid residues, nonpolar amino acid residues, positively charged amino acid residues, and negatively charged amino acid residues.

11. The method of claim 1, wherein the elected amino acid residue increases the free energy of binding between antibody and antigen when bound in a solvent, thereby decreasing antibody-antigen binding affinity.

12. The method of claim 1, wherein the elected amino acid residue decreases the free energy of binding between antibody and antigen when bound in a solvent, thereby increasing antibody-antigen binding affinity.

13. A method of modulating the antigen-binding affinity of an antibody comprising,
determining a spatial representation of an optimal charge distribution of the amino acids of the antibody and associated change in binding free energy of the antibody when bound to an antigen in a solvent,
identifying at least one candidate amino acid residue position of the antibody to be modified to alter the binding free energy of the antibody when bound to the antigen;
selecting an elected amino acid residue for substitution at said amino acid position;
modeling the elected amino acid residue for substitution in silico, calculating the change in free energy of binding of the modified antibody when bound to the antigen; and
substituting the elected amino acid residue for the candidate amino acid residue position such that the antigen-binding affinity of the antibody is modulated.

14. The method of claim 13, wherein the calculating step uses at least one determination selected from the group consisting of a determination of the electrostatic binding energy using a method based on the Poisson-Boltzmann equation, a determination of the van der Waals binding energy, and a determination of the binding energy using a method based on solvent accessible surface area.

15. The method of claim 13, further comprising expressing the modified antibody.

16. The method of claim 3, wherein in the method is repeated at least one time.

17. The method of claim 3, wherein in the method is conducted in silico.

18. The method of claim 3, wherein at least one step is informed by three-dimensional structural data.

19. The method of claim 3, wherein at least one step is informed by data selected from the group consisting of binding data derived from an expressed antibody binding to an antigen in a solvent, crystal structure data of an antibody, crystal structure data of an antibody bound to an antigen, three-dimensional structural data of an antibody, NMR structural data of an antibody, and computer-modeled structural data of an antibody.

20. The method of claim 8 or 15, wherein expressing the modified antibody is in an expression system selected from the group consisting of an acellular extract expression system, a phage display expression system, a prokaryotic cell expression system, and a eukaryotic cell expression system.

21. The method of claim 1, wherein the antibody, or antigen-binding fragment thereof, is modified at one or more positions within a CDR region(s) selected from the group consisting of V_{H} CDR1, V_{H} CDR2, V_{H} CDR3, V_{L} CDR1, V_{L} CDR2, and V_{L} CDR3.

22. The method of claim 1, wherein the antibody, or antigen-binding fragment thereof, is selected from the group consisting of an antibody, an antibody light chain (VL), an antibody heavy chain (VH), a single chain antibody (scFv), a F(ab′)2 fragment, a Fab fragment, an Fd fragment, and a single domain fragment.

23. The method of claim 1, wherein the antigen-binding affinity of the antibody is predicted to be increased by a factor of about 1.1, 1.2, 1.3, 1.4, 1.5, 1.6, 1.7, 1.8, 1.9, 2, 3, 5, 8, 10, 50, 10², 10³, 10⁴, 10⁵, or 10⁵, or 10⁶, 10⁷, or 10⁸.

24. The method of claim 1, wherein the antigen-binding affinity of the antibody is predicted to be decreased by a factor of about 1.1, 1.2, 1.3, 1.4, 1.5, 1.6, 1.7, 1.8, 1.9, 2, 3, 5, 8, 10, 50, 10², 10³, 10⁴, 10⁵, or 10⁶, 10⁷, or 10⁸.

25. The method of claim 1, wherein the antigen-binding affinity is determined in the presence of an aqueous solvent containing salt.

26. The method of claim 25, wherein the solvent comprises physiological concentrations of salt.

27. An antibody, or antigen-binding fragment thereof, produced by the method of any one of claims 1, 3 or 13.

28. An antibody, or antigen-binding fragment thereof, affinity matured according to the method of claim 3.

29. A plurality of antibodies, or antigen-binding fragments thereof, produced by the method of claim 3.

30. A nucleic acid encoding the antibody, or antigen-binding fragment thereof, of claim 27.

31. A host cell encoding the nucleic acid of claim 30.

32. An antibody, or binding fragment thereof, produced by culturing the host cell of claim 31 under conditions such that antibody, or binding fragment thereof, is expressed.

33. A pharmaceutical composition comprising the antibody, or antigen-binding fragment thereof, of claim 27.

34. A method for treating or preventing a human disorder or disease comprising,
administering a therapeutically-effective amount of the pharmaceutical composition of claim 33, such that therapy or prevention of the human disease or disorder is achieved.

35. The method of claim 3, wherein one or more steps is computer-assisted.

36. A medium suitable for use in an electronic device having instructions for carrying out one or more steps of the method of claim 3.

37. A device for carrying out one or more steps of the method of claim 3.
